(19) United States
(12) Patent Application Publication
(10) Pub. No.: US 2005/0065033 A1
(43) Pub. Date: Mar. 24, 2005

(54) Method to inhibit ethylene responses in plants

(76) Inventors: Richard Martin Jacobson, Chalfont, PA (US); Martha Jean Kelly, Collegeville, PA (US); Fiona Linette Wehmeyer, Roslyn, PA (US); Karen Anderson Evans, Harleysville, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 10/645,431

(22) Filed: Aug. 21, 2003

(51) Int. Cl. A01N 25/26; A01N 47/40; A01N 35/00; A01N 35/10

(52) U.S. Cl. 504/343; 504/344; 504/348; 564/253; 564/271

(57) ABSTRACT

The present invention generally relates to methods of inhibiting ethylene responses in plants and plant materials, and particularly relates to methods of inhibiting various ethylene responses including plant maturation and degradation, by exposing plants to cyclopropene derivatives and compositions thereof wherein: 1) at least one substituent on the cyclopropene ring contains a carbocyclic or heterocyclic ring, or 2) . a substituent contains silicon, sulfur, phosphorous, or boron, or 3) least one substituent contains from one to four non-hydrogen atoms and at least one substituent contains more than four non-hydrogen atoms.

The present invention generally relates to methods of inhibiting ethylene responses in plants and plant materials, and particularly relates to methods of inhibiting various ethylene responses including plant maturation and degradation, by exposing plants to cyclopropene derivatives and compositions thereof wherein at least one substituent on the cyclopropene ring contains a carbocyclic or heterocyclic ring.

It is well known that ethylene can cause the premature death of plants or plant parts including, for example, flowers, leaves, fruits, and vegetables. Ethylene also promotes leaf yellowing and stunted growth as well as premature fruit, flower, and leaf drop. Such activities are understood to be achieved through interaction with a specific ethylene receptor in the plant. Many compounds other than ethylene interact with this receptor: some mimic the action of ethylene; others prevent ethylene from binding and thereby counteract its action. To address these ethylene-induced effects, very active and intense research presently concerns the investigation of ways to prevent or reduce the deleterious effects of ethylene on plants.

Methods of combating the ethylene response in plants with diazocyclopentadiene and derivatives thereof are disclosed in U.S. Pat. No. 5,100,462 to Sisler et al. U.S. Pat. No. 5,518,988 to Sisler et al. discloses the use of cyclopropene and its derivatives, including 1-methylcyclopropene, as effective blocking agents for ethylene binding. However, a major problem with these compounds is that they are typically unstable gases which present explosive hazards when compressed.

Notwithstanding these efforts, there still remains a need in the art for compounds and compositions which will control plant maturation and degradation. Preferably, the new compounds will avoid the explosive hazards of 1-methylcyclopropene and, in addition, provide alternative means of delivery, such as through liquid or solid formulations.

We have discovered a new class of cyclopropene derivatives which provide many of the advantages noted above. These compounds, and their compositions, provide a method of inhibiting an ethylene response in a plant comprising the step of contacting the plant with an effective ethylene response-inhibiting amount of a cyclopropene derivative of the formula: 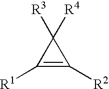
wherein:
a) one of R¹ and R³ is H and R², R⁴, and the other of R¹ and R³ are independently selected from H and a group of the formula:
   —(L)ₙ—Z
wherein:
   i) n is an integer from 1 to 12;
   ii) each L is independently selected from a member of the group D1, D2, E, or J wherein:
      D1 is of the formula: 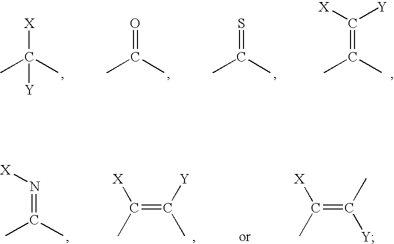
      D2 is of the formula: 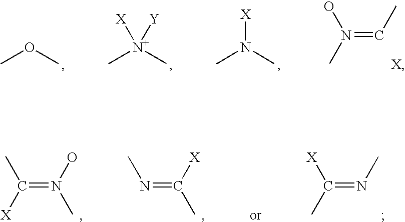
      E is of the formula: 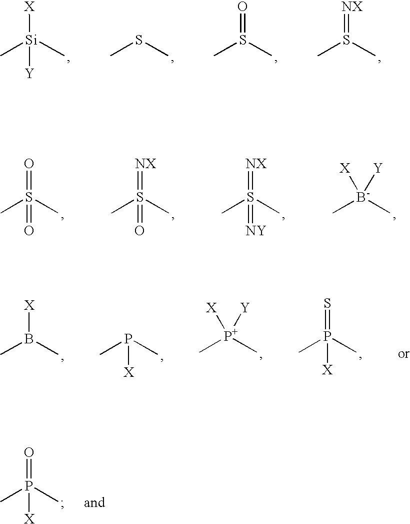
      J is of the formula: 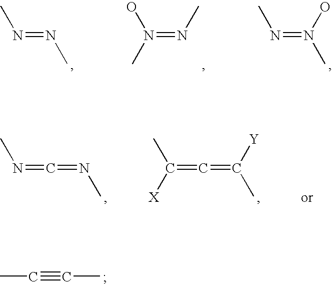
wherein:
   A) each X and Y is independently a group of the formula:
      —(L)ₘ—Z;
and
   B) m is an integer from 0 to 8; and
   C) no more than two D2 or E groups are adjacent to each other and no J groups are adjacent to each other;
iii) each Z is independently selected from:
   A) hydrogen, halo, cyano, nitro, nitroso, azido, chlorate, bromate, iodate, isocyanato, isocyanido, isothiocyanato, pentafluorothio, or
   B) a group G, wherein G is an unsubstituted or substituted; unsaturated, partially saturated, or saturated; monocyclic, bicyclic, tricyclic, or fused; 4 to 14 membered carbocyclic or heterocyclic ring system wherein;
      1) when the ring system contains a 4 membered heterocyclic ring, the heterocyclic ring contains 1 heteroatom;
      2) when the ring system contains a 5, or more, membered heterocyclic ring or a polycyclic heterocyclic ring, the heterocyclic or polycyclic heterocyclic ring contains from 1 to 4 heteroatoms;
      3) each heteroatom is independently selected from N, O, and S;
      4) the number of substituents is from 0 to 5 and each substituent is independently selected from X;
   b) the total number of non-hydrogen atoms in each compound is 50 or less; and
   c) the total number of heteroatoms in —(L)ₙ—Z is from 0 to 4; and
   d) either;
      i) R¹ or R³ contains at least one group G; or
      ii) at least one L group is an E group; or
      iii) at least one of R¹, R², R³, and R⁴ contains one to four non-hydrogen atoms and at least one of R¹, R², R³, and R⁴ contains more than four non-hydrogen atoms;
         and its enantiomers, stereoisomers, salts, and mixtures thereof;
         or a composition thereof.

For the purposes of this invention, in the structural representations of the various L groups each open bond indicates a bond to another L group, a Z group, or the cyclopropene moiety. For example, the structural representation 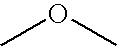
indicates an oxygen atom with bonds to two other atoms; it does not represent a dimethyl ether moiety.

Typical R¹, R², R³, and R⁴ groups include, for example: alkenyl, alkyl, alkynyl, acetylaminoalkenyl, acetylaminoalkyl, acetylaminoalkynyl, alkenoxy, alkoxy, alkynoxy, alkoxyalkoxyalkyl, alkoxyalkenyl, alkoxyalkyl, alkoxyalkynyl, alkoxycarbonylalkenyl, alkoxycarbonylalkyl, alkoxycarbonylalkynyl, alkylcarbonyl, alkylcarbonyloxyalkyl, alkyl(alkoxyimino)alkyl, carboxyalkenyl, carboxyalkyl, carboxyalkynyl, dialkylamino, haloalkoxyalkenyl, haloalkoxyalkyl, haloalkoxyalkynyl, haloalkenyl, haloalkyl, haloalkynyl, hydroxyalkenyl, hydroxyalkyl, hydroxyalkynyl, trialkylsilylalkenyl, trialkylsilylalkyl, trialkylsilylalkynyl, dialkylphosphonato, dialkylphosphato, dialkylthiophosphato, dialkylaminoalkyl, alkylsulfonylalkyl, alkylthioalkenyl, alkylthioalkyl, alkylthioalkynyl, dialkylaminosulfonyl, haloalkylthioalkenyl, haloalkylthioalkyl, haloalkylthioalkynyl, alkoxycarbonyloxy; cycloalkenyl, cycloalkyl, cycloalkynyl, acetylaminocycloalkenyl, acetylaminocycloalkyl, acetylaminocycloalkynyl, cycloalkenoxy, cycloalkoxy, cycloalkynoxy, alkoxyalkoxycycloalkyl, alkoxycycloalkenyl, alkoxycycloalkyl, alkoxycycloalkynyl, alkoxycarbonylcycloalkenyl, alkoxycarbonylcycloalkyl, alkoxycarbonylcycloalkynyl, cycloalkylcarbonyl, alkylcarbonyloxycycloalkyl, carboxycycloalkenyl, carboxycycloalkyl, carboxycycloalkynyl, dicycloalkylamino, halocycloalkoxycycloalkenyl, halocycloalkoxycycloalkyl, halocycloalkoxycycloalkynyl, halocycloalkenyl, halocycloalkyl, halocycloalkynyl, hydroxycycloalkenyl, hydroxycycloalkyl, hydroxycycloalkynyl, trialkylsilylcycloalkenyl, trialkylsilylcycloalkyl, trialkylsilylcycloalkynyl, dialkylaminocycloalkyl, alkylsulfonylcycloalkyl, cycloalkylcarbonyloxyalkyl, cycloalkylsulfonylalkyl, alkylthiocycloalkenyl, alkylthiocycloalkyl, alkylthiocycloalkynyl, dicycloalkylaminosulfonyl, haloalkylthiocycloalkenyl, haloalkylthiocycloalkyl, haloalkylthiocycloalkynyl; aryl, alkenylaryl, alkylaryl, alkynylaryl, acetylaminoaryl, aryloxy, alkoxyalkoxyaryl, alkoxyaryl, alkoxycarbonylaryl, arylcarbonyl, alkylcarbonyloxyaryl, carboxyaryl, diarylamino, haloalkoxyaryl, haloaryl, hydroxyaryl, trialkylsilylaryl, dialkylaminoaryl, alkylsulfonylaryl, arylsulfonylalkyl, alkylthioaryl, arylthioalkyl, diarylaminosulfonyl, haloalkylthioaryl; heteroaryl, alkenylheteroaryl, alkylheteroaryl, alkynylheteroaryl, acetylaminoheteroaryl, heteroaryloxy, alkoxyalkoxyheteroaryl, alkoxyheteroaryl, alkoxycarbonylheteroaryl, heteroarylcarbonyl, alkylcarbonyloxyheteroaryl, carboxyheteroaryl, diheteroarylamino, haloalkoxyheteroaryl, haloheteroaryl, hydroxyheteroaryl, trialkylsilylheteroaryl, dialkylaminoheteroaryl, alkylsulfonylheteroaryl, heteroarylsulfonylalkyl, alkylthioheteroaryl, heteroarylthioalkyl, diheteroarylaminosulfonyl, haloalkylthioheteroaryl; heterocyclyl, alkenylheteroycycyl, alkylheteroycycyl, alkynylheteroycycyl, acetylaminoheterocyclyl, heterocyclyloxy, alkoxyalkoxyheterocyclo, alkoxyheterocyclyl, alkoxycarbonylheterocyclyl, heterocyclylcarbonyl, alkylcarbonyloxyheterocyclyl, carboxyheterocyclyl, diheterocyclylamino, haloalkoxyheterocyclyl, haloheterocyclyl, hydroxyheterocyclyl, trialkylsilylheterocyclyl, dialkylaminoheterocyclyl, alkylsulfonylheterocyclyl, alkylthioheterocyclyl, heterocyclylthioalkyl, diheterocyclylaminosulfonyl, haloalkyllthioheterocyclyl; hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

Typical G groups include, for example: saturated or unsaturated cycloalkyl, bicyclic, tricyclic, polycyclic, saturated or unsaturated heterocyclic, unsubstituted or substituted phenyl, naphthyl, or heteroaryl ring systems such as, for example, cyclopropyl, cyclobutyl, cyclopent-3-en-1-yl, 3-methoxycyclohexan-1-yl, phenyl, 4-chlorophenyl, 4-fluorophenyl, 4-bromophenyl, 3-nitrophenyl, 2-methoxyphenyl, 2-methylphenyl, 3-methyphenyl, 4-methylphenyl, 4-ethylphenyl, 2-methyl-3-methoxyphenyl, 2,4-dibromophenyl, 3,5-difluorophenyl, 3,5-dimethylphenyl, 2,4,6-trichlorophenyl, 4-methoxyphenyl, naphthyl, 2-chloronaphthyl, 2,4dimethoxyphenyl, 4-(trifluoromethyl)phenyl, 2-iodo-4-methylphenyl, pyridin-2-yl, pyridin-3-yl, pyridin-4-yl, pyrazinyl, pyrimidin-2-yl, pyrimidin-4-yl, pyrimidin-5-yl, pyridazinyl, triazol-1-yl, imidazol-1-yl, thiophen-2-yl, thiophen-3-yl, furan-2-yl, furan-3-yl, pyrrolyl, oxazolyl, isoxazolyl, thiazolyl, isothiazolyl, oxadiazolyl, thiadiazolyl, quinolyl, isoquinolyl, tetrahydrofuryl, pyrrolidinyl, piperidinyl, tetrahydropyranyl, morpholinyl, piperazinyl, dioxolanyl, dioxanyl, indolinyl and 5-methyl-6-chromanyl, adamantyl, norbomyl, and their substituted analogs such as, for example: 3-butyl-pyridin-2-yl, 4-bromo-pyridin-2-yl, 5-carboethoxy-pyridin-2-yl, 6-methoxyethoxy-pyridin-2-yl,

Preferably, two of R¹, R², R³, and R⁴ are hydrogen. More preferably, R¹ and R² are hydrogen or R³ and R⁴ are hydrogen. Even more preferably, R², R³, and R⁴ are hydrogen or R¹, R², and R³ are hydrogen. Most preferably, R², R³, and R⁴ are hydrogen.

Preferably, n is from 0 to 8. Most preferably, n is from I to 7. Preferably, m is 0 to 4. Most preferably, m is from 0 to 2.

Preferably, D1 is —CXY—, —CO—, or —CS—. More preferably Dl is —CXY—. Preferably, D2 is —O—or —NX—. Preferably, E is —S—, —SiXY—, or —SO₂—. Preferably, X and Y are independently H, halo, OH, SH, —C(O)(C₁-C₄)alkyl-, —C(O)O(C₁-C₄)alkyl-, —O—(C₁-C₄)alkyl, —S—(C₁-C₄)alkyl, or substituted or unsubstituted (C₁-C₄)alkyl. Preferably, Z is H, halo, or G. More preferably, Z is H or G.

Preferably, each G is independently a substituted or unsubstituted; five, six, or seven membered; aryl, heteroaryl, heterocyclic, or cycloalkyl ring. More preferably, each G is independently a substituted or unsubstituted phenyl, pyridyl, cyclohexyl, cyclopentyl, cycloheptyl, pyrolyl, furyl, thiophenyl, triazolyl, pyrazolyl, 1,3-dioxolanyl, or morpholinyl. Even more preferably, G is unsubstituted or substituted phenyl, cyclopentyl, cycloheptyl, or cyclohexyl. Most preferably, G is cyclopentyl, cycloheptyl, cyclohexyl, phenyl, or substituted phenyl wherein the substituents are independently selected from 1 to 3 of methyl, methoxy, and halo.

Another aspect of the present invention is a method of blocking ethylene receptors in plants by applying to the plants an effective ethylene receptor-blocking amount of the cyclopropene derivative or a composition thereof.

Also disclosed are methods of inhibiting abscission in a plant, prolonging the life of a cut flower, and inhibiting the ripening of a picked fruit or vegetable, comprising applying to the plant an effective amount of the cyclopropene derivative or a composition thereof.

The methods described herein may be carried out in a variety of ways, such as by contacting the plant with a cyclopropene derivative or a composition thereof, whether in solid, liquid, or gaseous form, or by exposing the plant, cut flower, picked fruit or picked vegetable in an atmosphere infused with the cyclopropene derivative or a composition thereof. These and other suitable methods of application are discussed in detail below. For the purposes of this invention, “contacting” means to bring the cyclopropene and a plant into intimate association with each other such that a sufficient number of ethylene receptors are effected by the cyclopropene.

Agricultural compositions comprising the compounds of this invention are also encompassed by the invention. Preferably the compositions comprise 0.005% to 99%, by weight; preferably 1% to 95%, by weight; more preferably 2% to 90%, by weight; even more preferably 3% to 80%, by weight; or most preferably 4% to 70%, by weight, of the active compounds of the present invention. These compositions may comprise one or more adjuvants, such as, for example, carriers, extenders, binders, lubricants, surfactants and/or dispersants, wetting agents, spreading agents, dispersing agents, stickers, adhesives, defoamers, thickeners, and emulsifying agents. Such adjuvants commonly used in the art can be found in the John W. McCutcheon, Inc. publication Detergents and Emulsifiers, Annual, Allured Publishing Company, Ridgewood, N.J., U.S.A.

As used herein, all percentages are percent by weight and all parts are parts by weight, unless otherwise specified, and are inclusive and combinable. All ratios are by weight and all ratio ranges are inclusive and combinable. All molar ranges are inclusive and combinable.

Numerous organic solvents may be used as carriers for the active compounds of the present invention such as, for example, hydrocarbons such as hexane, benzene, toluene, xylene, kerosene, diesel oil, fuel oil and petroleum naphtha, ketones such as acetone, methyl ethyl ketone and cyclohexanone, chlorinated hydrocarbons such as methylene chloride, esters such as ethyl acetate, amyl acetate and butyl acetate, ethers, e.g., ethylene glycol monomethyl ether and diethylene glycol monomethyl ether, alcohols, e.g., ethanol, methanol, isopropanol, amyl alcohol, ethylene glycol, propylene glycol, butyl carbitol acetate and glycerine.

Mixtures of water and organic solvents, either as solutions or emulsions, can also be employed as inert carriers for the active compounds.

Solid, liquid, and gaseous formulations can be prepared by various conventional procedures. Thus, the active ingredient, in finely divided form if a solid, may be tumbled together with fmely divided solid carrier. Alternatively, the active ingredient in liquid form, including mixtures, solutions, dispersions, emulsions and suspensions thereof, may be admixed with a solid carrier in finely divided form. Furthermore, the active ingredient in solid form may be admixed with a liquid carrier to form a mixture, solution, dispersion, emulsion, suspension or the like.

The active compounds of the present invention can be applied to plants by various suitable means. For example, an active compound may be applied alone in gaseous, liquid, or solid form by contacting the compound with the plant to be treated. Additionally the active compound may be converted to the salt form, and then applied to the plants. Alternatively, compositions containing one or more active compounds of the present invention may be formed. The compositions may be applied in gaseous, liquid, or solid form by contacting the composition with the plant to be treated. Such compositions may include an inert carrier. Similarly, when in gaseous form, the compound may be dispersed in an inert gaseous carrier to provide a gaseous solution. The active compound may also be suspended in a liquid solution such as an organic solvent or an aqueous solution that may serve as the inert carrier. Solutions containing the active compound may be heterogeneous or homogeneous and may be of various forms including mixtures, dispersions, emulsions, suspensions and the like.

The cyclopropenes may also be encapsulated into a molecular encapsulation agent. Preferred encapsulating agents include cyclodextrins, crown ethers, polysiloxanes, and zeolites. More preferred encapsulating agents include α-cyclodextrin, β-cyclodextrin, and γ-cyclodextrin. The most preferred encapsulating agent will vary depending upon the size of the R substituents. However, as one skilled in the art will appreciate, any cyclodextrin or mixture of cyclodextrins, cyclodextrin polymers as well as modified cyclodextrins can also be utilized pursuant to the present invention. Cyclodextrins are available from Wacker Biochem Inc., Adrian, Mich. or Cerestar USA, Hammond, Ind., as well as other vendors. When encapsulated, the preferred concentrations of the cyclopropenes will typically be less than in other compositions due to the capacity limitations of molecular encapsulation agents.

The active compounds and compositions thereof can also be applied as aerosols, e.g., by dispersing them in air using a compressed gas such as, for example, nitrogen, carbon dioxide, dichlorodifluoromethane, trichlorofluoromethane, or other halocarbons.

The amount of the cyclopropene needed to inhibit ethylene effects will vary depending upon the particular cyclopropene, the type and amount of plant material present, the cyclopropene composition used, and the volume to be treated. Generally, a gas treatment (measured volume/volume) concentration of the cyclopropene in the treated chamber of from about 0.1 part per billion (“ppb”) to 1000 parts per million (“ppm”) provides adequate ethylene inhibition. Likewise, an applied spray treatment (measured weight/weight) concentration of the cyclopropene of from about 0.01 part per billion (“ppb”) to 1000 parts per million (“ppm”) provides adequate ethylene inhibition.

The term “plant” is used in a generic sense herein, and includes, for example, woody-stemmed plants such as trees and shrubs; herbs; vegetables, fruits, and agricultural crop;, and ornamental plants. Plants to be treated by the methods described herein include whole plants and any portions thereof, such as field crops, potted plants, seeds, cut flowers (stems and flowers), and harvested fruits and vegetables.

Plants treated with the compounds and by the methods of the present invention are preferably treated with a non-phytotoxic amount of the active compound.

The present invention can be employed to modify a variety of different ethylene responses such as, for example, the ripening and/or senescence of flowers, fruits, and vegetables; abscission of foliage, flowers, and fruit; the shortening of life of omamentals such as potted plants, cut flowers, shrubbery, seeds, and dormant seedlings; in some plants (e.g., pea) the inhibition of growth, the stimulation of growth (e.g., rice), auxin activity, inhibition of terminal growth, control of apical dominance, increase in branching, increase in tillering, changing the morphology of plants, modifying the susceptibility to plant pathogens such as fungi, changing bio-chemical compositions of plants (such as increasing leaf area relative to stem area), abortion or inhibition of flowering and seed development, lodging effects, stimulation of seed germination and breaking of dormancy, and hormone or epinasty effects.

Active compounds of the present invention have proven to be unexpectedly potent inhibitors of ethylene action on plants, fruits and vegetables, even when applied at low concentrations. Among other things, compounds of the present invention may result in a longer period of insensitivity to ethylene than compounds found in the prior art. This longer period of insensitivity may occur even when compounds of the present invention are applied at a lower concentration than previous compounds.

Another embodiment of this invention relates to members of the class of cyclopropenes which are newly discovered compounds. These compounds include compounds of the formula: 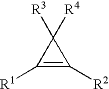
wherein:
a) one of R¹ and R³ is H and R², R⁴, and the other of R¹ and R³ are independently selected from H and a group of the formula:
   —(L)ₙ—Z
wherein:
   i) n is an integer from 1 to 12;
   ii) each L is independently selected from a member of the group D1, D2, E, or J wherein:
      D1 is of the formula: 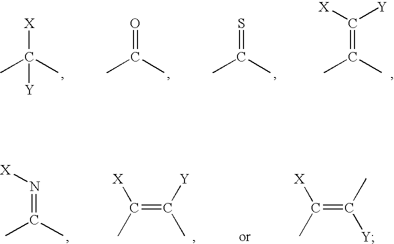
      D2 is of the formula: 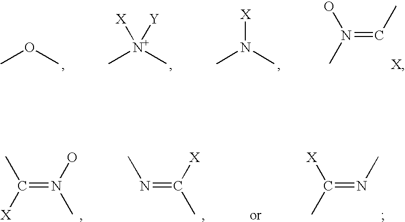
      E is of the formula: 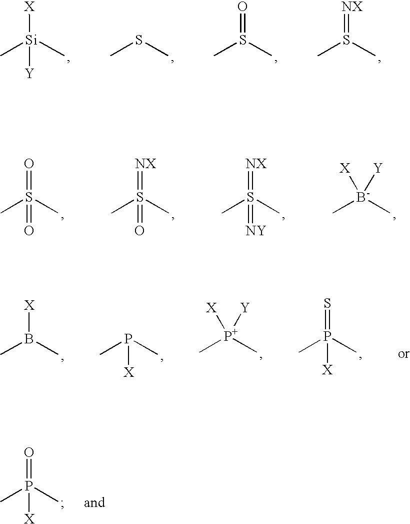
      J is of the formula: 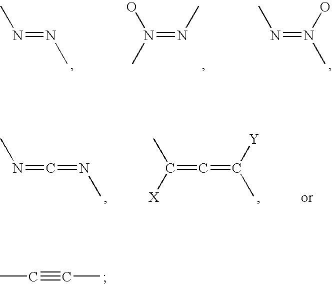
wherein:
   A) each X and Y is independently a group of the formula:
      —(L)ₘ—Z;
and
   B) m is an integer from 0 to 8; and
   C) no more than two D2 or E groups are adjacent to each other and no J groups are adjacent to each other;
iii) each Z is independently selected from:
   A) hydrogen, halo, cyano, nitro, nitroso, azido, chlorate, bromate, iodate, isocyanato, isocyanido, isothiocyanato, pentafluorothio, or
   B) a group G, wherein G is an unsubstituted or substituted; unsaturated, partially saturated, or saturated; monocyclic, bicyclic, tricyclic, or fused; 4 to 14 membered carbocyclic or heterocyclic ring system wherein;
      1) when the ring system contains a 4 membered heterocyclic ring, the heterocyclic ring contains 1 heteroatom;
      2) when the ring system contains a 5, or more, membered heterocyclic ring or a polycyclic heterocyclic ring, the heterocyclic or polycyclic heterocyclic ring contains from 1 to 4 heteroatoms;
      3) each heteroatom is independently selected from N, O, and S;
      4) the number of substituents is from 0 to 5 and each substituent is independently selected from X;
   b) the total number of non-hydrogen atoms in each compound is 50 or less; and
   c) the total number of heteroatoms in —(L)ₙ—Z is from 0 to 4; and
   d) either;
      i) R¹ or R³ contains at least one group G; or
      ii) at least one L group is an E group; or
      iii) at least one of R¹, R², R³, and R⁴ contains one to four non-hydrogen atoms and at least one of R¹, R², R³, and R⁴ contains more than four non-hydrogen atoms; andits enantiomers, stereoisomers, salts, and mixtures thereof;
or a composition thereof;
provided that:
   a) —(L)ₙ—Z is other than trimethylsilyl, trimethylsilylsulfonyl or thiol; and
   b) R¹ is other than phenylsulfonyl, phenylthioethyl, diphenylhydroxymethyl, benzo[g]quinolin-7-ol- 1-methyl, a malonate derivative, a substituted 3-aminocyclohexenone, a dialkoxybenzylaminocarbonyl; and
   c) R³ is other than 2-phenyl-ethenyl, phenylthio, (4-bromo-2-methylphenyl)carbamic acid N-carbonyl, (4-bromo-2-methylphenyl)carbamic acid ethyl ester N-carbonyl, a malonate derivative, aryloxy, or a dialkoxybenzylaminecarbonyl.

The compounds of this invention can be prepared by a number of methods. For general references see Closs, G. L. Advan. Alicyclic Chem. 1966, 1, 53-127 and Al Dulayymi, A. R.; Al Dulayymi, J. R; Baird, M. S.; and Koza, G. Russian Journal of Organic Chemistry 1997, 33, 798-816.

The reaction of a bromo-olefin with dibromocarbene gives a tribromocyclopropane, which can be converted to the cyclopropene with methyllithium or other organolithium compounds as shown. (see Baird, M. S.; Hussain, H. H.; Nethercott, W J. Chem. Soc. Perkin Trans. 1, 1986, 1845-1854 and Baird, M. S.; Fitton, H. L.; Clegg, W; McCamley, A. J. Chem. Soc. Perkin Trans. 1, 1993, 321-326). If one equivalent of methyllithium or other alkyllithium is used, the mono-brominated cyclopropene is obtained. With 2 or more equivalents of the alkyllithium, the lithiated cyclopropene is formed. This can be quenched with water to give the cyclopropenes shown (E═H). Alternatively, the cyclopropenyllithium can be reacted with electrophiles to give derivatived cyclopropenes. Examples of such electrophiles include alkylating agents, trisubstituted chlorosilanes, borates, dialkyl or diaryl disulfides, ketones, aldehydes, esters, amides and nitrites.

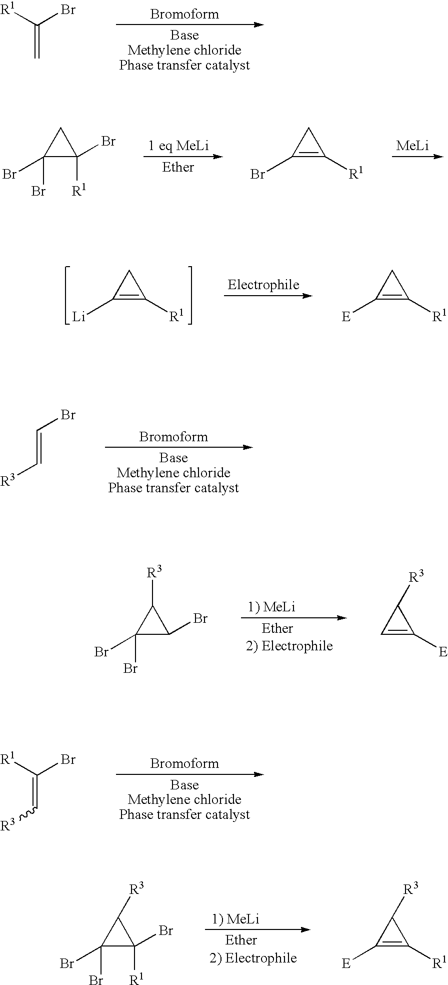

The bromo-olefins can be prepared by standard methods. Chloro-olefins can be used in place of bromo-olefins.

The tribrominated cyclopropanes can also be converted to mono-brominated cyclopropanes with reducing agents such as diethylphosphite. Other reducing agents could be used.

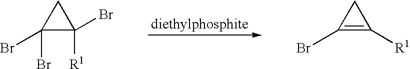

A 1,1-disubstituted olefin can also react with dibromocarbene to give a dibrominated intermediate. This can be reduced with zinc to the mono-brominated cyclopropane. Elimination of the bromide with base gives the cyclopropene (reference Binger, P. Synthesis 1974, 190).

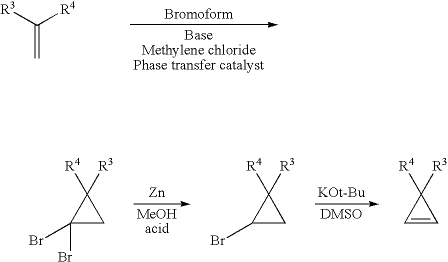

Cyclopropene can be deprotonated with a strong base such as sodium amide in liquid ammonia and reacted with an alkyl halide or other electrophiles to give a substituted cyclopropene (reference: Schipperijn, A. J.; Smael, P.; Recl. Trav. Chim. Pays-Bas, 1973, 92, 1159). Substituted cyclopropenes can be deprotonated with alkyllithium reagents and reacted with electrophiles.

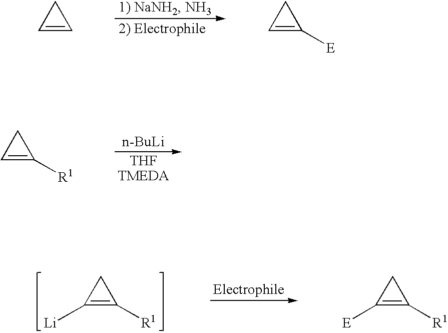

Tribromocyclopropanes or cyclopropenes containing an alcohol can be converted to a good leaving group such as a sulfonate derivative. The leaving group can be displaced with nucleophiles to give other substituted cyclopropenes.

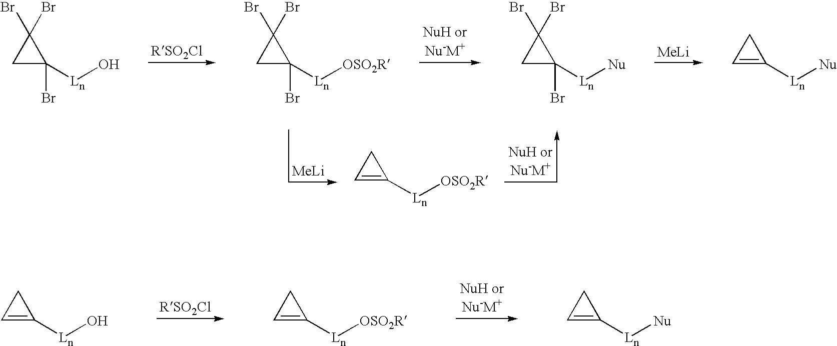

A 1-trialkylsilyl-2-hydroxycyclopropane, generated from vinyltrialkylsilane, can serve as a precursor to a cyclopropene (Mizojiri, R.; Urabe, H.; Sato, F. J. Org Chem. 2000, 65, 6217).

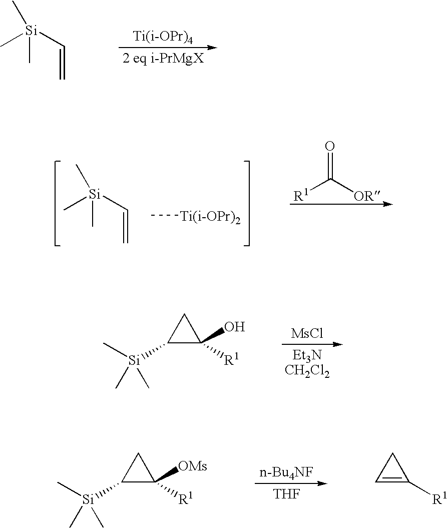

1-Trialkylsilyl-2-halocyclopropanes also undergo a fluoride catalyzed elimination to give cyclopropenes (Billups, W. E.; Lee, G-A; Arney, B. E.; Whitmire, K. H. J. Am. Chem. Soc., 1991, 113, 7980. and Banwell, M. G.; Corbett, M.; Gulbis, J.; Mackay, M.F.; Reum, M. E. J. Chem. Soc. Perkin Trans. 1, 1993, 945).

The addition of a diazo compound to an acetylene is another method that can be used for the synthesis of cyclopropenes (Mueller, P.; Cranisher, C; Helv. Chim. Acta 1993, 76, 521).

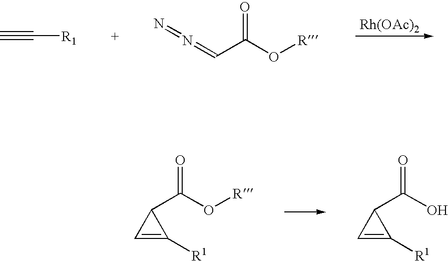

The esters can be hydrolyzed to the carboxylic acid.

Similarly, dihalocarbenes can be added to acetylenes to give 1-alkyl-3,3-dihalocyclopropenes (Bessard, Y.; Schlosser, M.; Tetrahedron, 1991, 47, 7323).

Compounds of this invention can also be obtained from a malonate derivative as shown.

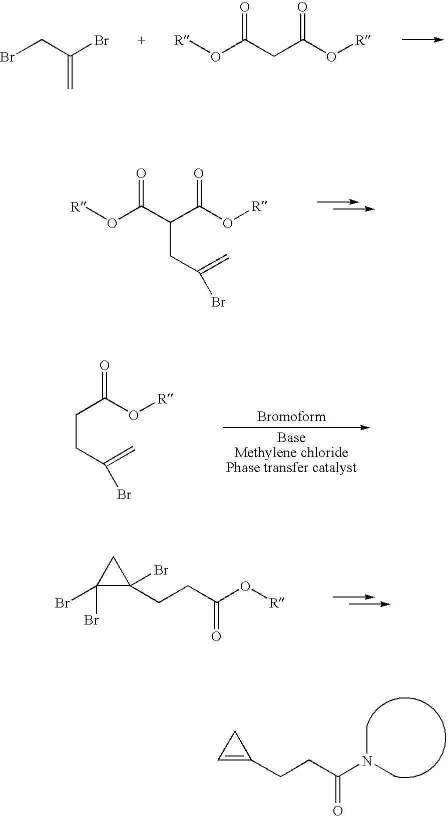

Other methods for making cyclopropenes can be found in the following references: Duerr, H., Angew. Chem. 1967, 24, 1104; Closs et al., J. Am. Chem. 1963, 85, 3796; Baird, M. S.; Dale, C. M.; Al Dulayymi, J. R. J. Chem. Soc. Perkin Trans. 1, 1993, 1373-1374; Koster, R. et al., Liebigs Annalen Chem. 1973, 1219-1235; Closs, G. L.; Closs, L. E., J. Am. Chem. Soc., 1961, 83, 1003-1004; Stoll, A. T.; Negishi, E., Tetrahedron Lett. 1985, 26, 5671-5674.

### EXAMPLES

General: All cyclopropenes were stored at −80° C. All reactions were carried out under an atmosphere of nitrogen. Flash chromatography of cyclopropenes was carried out under an atmosphere of nitrogen. All target compounds were 80% or greater purity unless otherwise noted. 1-Substitued cyclopropenes are never heated, and care should be taken to minimize the amount of time that these compounds are at room temperature.

### Example 1

### Preparation of 1-Chloro4-cycloprop-1-enylmethyl-benzene (Compound 1)

a. 1-(2-Bromo-allyl)4-chloro-benzene

A solution of 8 ml (0.0622 mol) of 2,3-dibromopropene in 50 ml diethyl ether was placed under a nitrogen atmosphere by use of a Firestone valve. While cooling in an ice water bath, a solution of 62 ml (0.062 mol) of 1 M 4-chlorophenylmagnesium bromide in diethyl ether was added slowly via addition funnel. After stirring for 2 hours while warming to room temperature, the reaction was recooled in an ice bath and 50 ml of 1 N hydrochloric acid was then added via syringe. The resulting mixture was transferred to a separatory funnel and the phases were separated. The organic layer was dried over MgSO₄ and filtered. The solvent was removed from the filtrate in vacuo. The residue was triturated with cold pentanes to yield 12.0 g of 1-(2-bromo-allyl)-4-chloro-benzene as an oil which was used in without further purification.

b. 2-(4-Chlorophenylmethyl)-1,1,2-tribromocyclopropane

To a solution of 11.4 g (0.0494 mol) of 1-(2-bromo-allyl)4-chloro-benzene in 20 ml of bromoform was added 0.686 g (0.00213 mol) tetrabutylammonium bromide. After heating to 58.5° C. for an hour, 10.7 ml (0.0494 mol) of 50% aqueous sodium hydroxide was added. This was repeated seven times over two days. After cooling to room temperature there was added hexanes and water. This mixture was gravity filtered through qualitative fluted filter paper. The resulting mixture was transferred to a separatory funnel and the phases were separated. The organic layer was dried over MgSO₄ and filtered. The solvent was removed from the filtrate in vacuo. This residue was purified by column chromatography with hexanes to give 2.3 g of 2-(4-chlorophenylmethyl)-1,1,2-tribromocyclopropane.

c. 1-(4-Chlorophenylmethyl)-cyclopropene

A solution of 1.20 g (0.00298 mol) of 2-(4-chlorophenylmethyl)-1,1,2-tribromocyclopropane in 6 ml of diethyl ether was placed under a nitrogen atmosphere via use of a Firestone valve. While cooling in an ice water bath, 6.38 ml (0.00893 mol) of 1.4M methyl lithium in diethyl ether was added slowly by syringe. After 15 minutes, 2 ml of water was added via syringe. The resulting mixture was transferred to a separatory funnel and the phases were separated. The organic layer was dried over MgSO₄ and filtered. The solvent was removed from the filtrate in vacuo with a bath temperature under 20° C. to yield 0.430 g of 1-(4-chlorophenylmethyl)-cyclopropene as an oil.

### Example 2

### Preparation of 1-( 2-Thienyl)methyl-cyclopropene (Compound 2)

The Grignard reagent of 2-bromothiophene was prepared, and converted to 1-(2-thienyl)methyl-cyclopropene by the same reaction sequence as was used for the preparation of compound 1.

### Example 3

### Preparation of 2-(3-Cycloprop-1-enyl-propyl)-[1,3]dioxane (Compound 3)

The Grignard reagent of 2-(2-bromoethyl)-1,3-dioxane was prepared, and converted to 2-(3-cycloprop-1-enyl-propyl)-[1,3]dioxane by the same reaction sequence as was used for the preparation of compound 1.

### Example 4

### Preparation of 1-(6-(Phenyldimethylsilyl)-hexyl)-cyclopropene (Compound 4)

a. 2-Bromo-8-(phenyldimethylsilyl)-oct-1-ene

Commercially available pentamethylenebis(magnesium bromide) (37 ml, 0.5 M in THF, 18.5 mmol) was cooled in an ice bath. A solution of 3.16 g (18.5 mmol) of phenyldimethylchlorosilane in roughly 7 ml of TUF was added. The reaction mixture was stirred at 5° C. for 15 minutes then at room temperature for 35 minutes, then recooled to 5° C. 2,3-Dibromopropene (3.7 g, 18.5 mmol) in roughly 5 ml of THF was added to the reaction mixture, which was held at 5° C. for 5 minutes, then warmed to room temperature and stirred overnight. The reaction mixture was quenched with water. Ether and a small amount of 1N HCl was added. The phases were separated, and the organic phase was washed with water and brine, dried over magnesium chloride and stripped. Column chromatography gave 1.47 g of 2-bromo-8-(phenyldimethylsilyl)-oct-1-ene as a colorless oil.

b. N,N′-dibenzyl-N,N,N′,N′-tetramethylethylenediammonium dibromide and N,N′-dibenzyl-N,N,N′,N′-tetraethylethylenediammonium dibromide (Phase transfer catalysts)

To a stirred solution of 16.5 g (142 mmol) of N,N,N′,N′-tetramethylethylenediamine in 60 g of acetonitrile was added 50.1 g (292 mmol) of benzyl bromide. The mixture self warmed and was allowed to stir for 2.5 hours whereon a heavy precipitate was observed. The slurry was diluted with diethyl ether, filtered, washed with diethyl ether and dried yielding 61.8 g of the desired N,N′-dibenzyl-N,N,N′,N′-tetramethylethylenediammonium dibromide, a white solid mp 230-232° C.

In an analogous way, using N,N,N′,N′-tetraethylethylenediamine one obtains N,N′-dibenzyl-N,N,N′,N′-tetraethylethylenediammonium dibromide, a white solid mp 190-193° C., decomposes.

C. 2-(6-(Phenyldimethylsilyl)-hexyl)-1,1,2-tribromocyclopropane

A mixture of 1.4 g (4.3 mmol) of 2-bromo-8-(phenyldimethylsilyl)-oct-1-ene, 3.2 g of 45% aqueous potassium hydroxide solution (25.6 mmol), 0.2 g N,N′-dibenzyl-N,N,N′,N′-tetraethylethylenediammonium dibromide, and 7.5 ml of methylene chloride was treated with 1.1 ml of bromoform (12.6 mmol). The well-stirred reaction mixture was held overnight at room temperature. Water and methylene chloride were added, the phases were separated.

The methylene chloride phase was dried over magnesium sulfate, and stripped. A small amount of heptane was added during the strip to help remove remaining bromoform. Column chromatography gave 1.02 g of 2-(6-(phenyldimethylsilyl)-hexyl)-1,1,2-tribromocyclopropane as a colorless liquid.

d. 1-(6-(Phenyldimethylsilyl)-hexyl)-cyclopropene

A solution of 0.95 g (1.9 mmol) of 2-(6-(phenyldimethylsilyl)-hexyl)-1,1,2-tribromocyclopropane in ether was cooled to −78° C. Excess methyllithium (1.4M, 4.1 ml, 5.7 mmol) was added, and the reaction mixture was placed in an ice bath for 30 min, then quenched with water. The phases were separated. The ether phase was washed with water, washed with brine, dried over magnesium sulfate and stripped to give 200 mg of 1-(6-(phenyldimethylsilyl)-hexyl)-cyclopropene as a colorless liquid.

### Example 5

### Preparation of 1-(α,α-dimethylbenzyl)-cycloprolpene (Compound 5)

a. α,α-dimethylbenzylcyanide

Into a 1000 ml 3 necked flask with mechanical stirring, an external water bath, an internal thermometer, a condenser and an addition funnel was added 250 g of dimethyl sulfoxide, 59 g (504 mmol) of benzyl cyanide, and 160 g (1127 mmol) of methyl iodide. The internal temperature was raised to +45° C. and then 83 g of 50% aqueous NaOH was added at 0.7 drops per second. After two hours the addition was complete. The thick slurry was cooled, diluted with 1000 ml of water and 500 ml of diethyl ether and 500 ml of hexane. The organic layer was separated and concentrated. It contained mono and dimethylated compounds. To this concentrate was further added 250 g of dimethyl sulfoxide, 60 g of methyl iodide, and 37 g of 50% aqueous NaOH for two hours as above. After cooling, dilution with 1000 ml of water, 500 ml of diethyl ether, and 500 ml of hexane gave an organic layer which was washed with 500 ml of water, dried over anhydrous magnesium sulfate and evaporated in vacuo yielding 69 g of α,α-dimethylbenzylcyanide.

b. α,α-Dimethylbenzyl Methyl Ketone

Into a 500 ml round bottomed flask with magnetic stirring, a reflux condenser and a septum under an atmosphere of dry nitrogen was added 30 g (207 mmol) of α,α-dimethylbenzylcyanide and 200 ml of diethyl ether. Methyllithium (1.4 M, 160 ml, 224 mmol) in diethyl ether was added via cannula over three minutes. The reaction exothermed to a mild reflux during the addition. After stirring for 20 minutes, the reaction was quenched by the slow addition of 45 ml of concentrated aqueous hydrochloric acid diluted with 100 ml of water. After stirring for one hour, the organic layer was separated, dried over anhydrous magnesium sulfate, and evaporated in vacuo yielding 32 g of α,α-dimethylbenzyl methyl ketone.

c. 1-(α,α-Dimethylbenzyl)-1-chloroethylene

Into a 250 ml round bottomed flask equipped with magnetic stirring and a reflux condenser was placed 15 g (98 mmol) of POCl₃, 30 g (145 mmol) of PCl5, and 19.9 g (123. mmol) of α,α-dimethylbenzyl methyl ketone. The reaction was heated in an oil bath to an external temperature of 110° C. Gas evolution ceased after one hour. The reaction was cooled and carefully poured onto ice and aqueous ammonium hydroxide. Extractive workup with diethyl ether gave a mixture of 1-(α,α-dimethylbenzyl)-1-chloroethylene and 1-(α,α-dimethylbenzyl)-1,1-dichloroethane. Vacuum distillation gave purified 1-(α,α-dimethylbenzyl)-1-chloroethylene bp (23 torr) 110-120° C.

d. 1-(α,α-Dimethylbenzyl)-1-chloro-2,2-dibromocyclopropane

Into a 100 ml round bottomed flask equipped with magnetic stirring was added 4.5 g (25 mmol) of 1-(α,α-dimethylbenzyl)-1-chloroethylene, 25 g (100 mmol) of bromoform, 27 g of methylene chloride, 0.37 g of N,N′-dibenzyl-N,N,N′N′-tetramethylethylenediammonium dibromide, and 12.4 g (100 mmol) of 45% aqueous KOH. Rapid stirring overnight gave a 20% conversion to the desired cyclopropane. Washing the aqueous layer with water and resubmitting with fresh bromoforrn, catalyst, and KOH overnight gave further conversion. A third submission was deemed adequate. The aqueous washed organic layer was evaporated in vacuo and chromatographed on silica gel using 2% diethyl ether in hexane yielding 4.2 g of 1-(α,α-dimethylbenzyl)-1-chloro-2,2-dibromocyclopropane.

e. 1-(α,α-Dimethylbenzyl)-cyclopropene

Into a 50 ml flask equipped with a stirbar and septum and under an atmosphere of dry nitrogen was added 1.73 g (4.9 mmol) of 1-(α,α-dimethylbenzyl)-1-chloro-2,2-dibromocyclopropane and 12 ml of diethyl ether. After cooling in an ice bath for 10 minutes, 9.0 ml (12.6 mmol) of 1.4 M methyllithium in diethyl ether was added via syringe. A precipitate formed immediately. After stirring for 10 minutes the reaction was quenched with 3 ml of water. The aqueous layer was removed and the organic layer was dried over anhydrous magnesium sulfate and evaporated in vacuo with the bath temperature at +25° C. yielding 0.94 g of 1-(α,α-dimethylbenzyl)-cyclopropene.

### Example 6

### Preparation of 3-Methyl-3-phenylcyclopropene (Compound 6)

a. 2,2-Dibromo-1 -methyl-1-phenylcyclopropane

To a solution of 12.5 ml (0.0963 mol) of α-methylstyrene in 30.4 ml (0.348 mol) of bromoform and 1.34 g (0.00416 mol) of tetrabutylammonium bromide was added slowly via addition funnel 20.9 ml (0.400 mol) of 50% aqueous sodium hydroxide. After heating to 55° C. for 1 hour 20.9 ml (0.400 mol) of 50% aqueous sodium hydroxide was added. After 2 additional hours of heating, the reaction was cooled to room temperature when hexanes and water were added. The resulting mixture was transferred to a separatory funnel and the phases were separated. The organic layer was dried over MgSO₄ and filtered. The solvent was removed from the filtrate in vacuo. The product was isolated by vacuum distillation to yield 24.1 g of 2,2-dibromo-1-methyl-1-phenylcyclopropane as an oil.

b. 2-Bromo-1-methyl-1-phenylcyclopropane

To a solution of 6.40 g (0.0221 mol) of 2,2-dibromo-1-methyl-1-phenylcyclopropane in 22 g of methanol was added 2.16 g (0.0360 mol) glacial acetic acid and 2.11 g (0.0323 mol) of zinc dust. After stirring at room temperature for 4 hours, the solvent was removed in vacuo. To the resulting residue hexanes and water were added. The resulting mixture was transferred to a separatory funnel and the phases were separated. The organic layer was dried over MgSO₄ and filtered. The solvent was removed from the filtrate in vacuo to yield 3.24 g of 2-bromo-1-methyl-1-phenylcyclopropane as an oil which was used without further purification.

c. 3-Methyl-3-phenylcyclopropene

To a solution of 1.56 g (0.00739 mol) of 2-bromo-1-methyl-1-phenylcyclopropane in 5 ml of dimethylsulfoxide was added 1.429 g (0.0127 mol) of potassium tert-butoxide. After the reaction was heated to 72° C. for 4 hours, diethyl ether and water were added. The resulting mixture was transferred to a separatory funnel and the phases were separated. The organic layer was dried over MgSO₄ and filtered. The solvent was removed from the filtrate in vacuo to yield 0.88 g of 70% pure 3-methyl-3-phenylcyclopropene as an oil. The major byproduct (roughly 20%) was 1-methyl-1-phenylcyclopropane.

### Example 7

### Preparation of 3-Methyl-3-Phenoxymethylcycloprop-2-ene (Compound 7)

Methallyl phenyl ether was converted to 3-methyl-3-phenoxymethylcycloprop-2-ene with 90% purity in a similar manner to the conversion of α-methylstyrene to 3-methyl-3-phenylcyclopropene (Example 6).

### Example 8

### Preparation of 1-methy1-2-benzylcyclopropene (Compound 8)

Into a 50 ml flask equipped with a stirbar and septum and under an atmosphere of dry nitrogen was added 1 mg of 1,10-phenanthroline, 1.34 g (11.5 mmol) of N,N,N′,N′-tetramethylethylenediamine, and 25 ml of tetrahydrofuran. The mixture was cooled to −30° C. and 1.5 ml (22 mmol) of 1-methylcyclopropene (prepared from 3-chloro-2-methyl-propene; see Hopf, H.; Wachholz, G.; Walsh, R. Chem. Ber. 1985, 118, 3579, and Koster, R et al., Liebigs Annalen Chem. 1973, 1219-1235) was added via syringe. Addition of 1.0 ml of 1.6 M butyllithium in hexanes was needed to produce a dark rust colored solution. Further addition of 6.0 ml of the 1.6 M butyllithium solution (9.6 mmol) and stirring for 15 minutes at −30° C. gave a solution of the lithiated 1-methylcyclopropene. Addition of 1.64 g of benzyl bromide and slow warming over 20 minutes to +5° C. gave lightened color. The reaction was quenched with 0.5 ml of methanol, rapidly evaporated in vacuo with a bath temperature of +25° C., partitioned between diethyl ether and dilute aqueous hydrochloric acid, dried with anhydrous magnesium sulfate and re-evaporated in vacuo yielding 1.3 g of 1-methyl-2-benzylcyclopropene.

### Example 9

### 1-(2-(4-Chlorophenylthio)ethyl)cyclopropene (Compound 9)

a. 2-Bromo4-(1-ethoxy-ethoxy)-but-1-ene

While cooling a solution of 10.38 g (0.0687 mol) of 3-bromo-3-buten-1-ol in 20 ml of diethyl ether with 50 mg (0.000263 mol) p-toluene sulfonic acid monohydrate in an ice water bath, 19 ml (0.199 mol) of ethyl vinyl ether was added slowly dropwise to maintain an internal temperature of <10° C. After 1 hour at 0° C., a few drops of triethylamine was added. The reaction mixture was poured onto water. The resulting mixture was transferred to a separatory funnel and the phases were separated. The isolated organic layer was washed with brine then dried over potassium carbonate and filtered. The solvent was removed from the filtrate in vacuo to yield 14.04 g of 2-bromo-4-(1-ethoxy-ethoxy)-but-1-ene as an oil.

b. 1,1,2-Tribromo-2-[2-(1-ethoxy-ethoxy)-ethyl]-cyclopropane To a solution of 14.02 g (0.0628 mol) 2-bromo4-(1-ethoxy-ethoxy)-but-1-ene in 108 ml methylene chloride with 0.5-0.9 ml 45% aqueous potassium hydroxide was added 16.4 ml (0.118 mol) of bromoform and 2.88 g (0.00628 mol) of N,N′-dibenzyl-N,N,N′,N′-tetramethylethylenediammonium dibromide and 28 ml (0.314 mol) 45% aqueous potassium hydroxide. After 3 days the reaction mixture was poured onto water. The resulting mixture was transferred to a separatory funnel and the phases were separated. To the isolated organic layer was added 2.88 g (0.00628 mol) of N,N′-dibenzyl-N,N,N′,N′-tetramethylethylenediammonium dibromide and 28 ml (0.314 mol) 45% aqueous potassium hydroxide. After 24 hours, hexanes and water were added. This mixture was gravity filtered through qualitative fluted filter paper. The resulting mixture was transferred to a separatory funnel and the phases were separated. The organic layer was dried over MgSO₄ and filtered. The solvent was removed from the filtrate in vacuo to yield 17.0 g of 1,1,2-tribromo-2-[2-(1-ethoxy-ethoxy)-ethyl]-cyclopropane as an oil.

c. 1,1,2-Tribromo-2-(2-hydroxyethyl)cyclopropane

To a slurry of 16.5 g (0.0418 mol) of 1,1,2-tribromo-2-[2-(1-ethoxy-ethoxy)-ethyl]-cyclopropane in 145 ml methanol and 40 ml water, was added 0.306 g (0.00161 mol) p-toluene sulfonic acid monohydrate and 145 ml 6M hydrochloric acid. After stirring at room temperature for 1 hour, the solvent was removed from the reaction mixture in vacuo. To the residue, there was added ethyl acetate and water. The resulting mixture was transferred to a separatory funnel and the phases were separated. The isolated organic layer was washed with brine then dried over MgSO₄ and filtered. The solvent was removed from the filtrate in vacuo to yield 11.9 g of 1,1,2-tribromo-2-(2-hydroxyethyl)cyclopropane as an oil.

d. 1,1,2-Tribromo-2-(2-benzenesulfonyloxyethyl)cyclopropane

While cooling a solution of 3.00 g (0.00929 mol) of 1,1,2-tribromo-2-(2-hydroxyethyl)cyclopropane in methylene chloride with 0.901 ml (0.0111 mol) pyridine to 0° C., 1.18 ml (0.00929 mol) of benzene sulfonyl chloride was added dropwise via pipet. Allowed to warm to room temperature. After 3 days, water was added. The resulting mixture was transferred to a separatory funnel and the phases were separated. The organic layer was dried over MgSO₄ and filtered. The solvent was removed from the filtrate in vacuo to yield 3.10 g of 80% pure 1,1,2-tribromo-2-(2-benzenesulfonyloxyethyl)cyclopropane as an oil.

e. 2-(2-(4-Chlorophenylthio)ethyl)-1,1,2-tribromocyclopropane

To a solution of 0.234 g (0.162 mol) of 4-chlorothiophenol in 3 ml methanol was added 0.371 ml (0.00162 mol) of 25% sodium methoxide in methanol. After stirring at room temperature for about 1 hour, the solvent was removed in vacuo. A solution of 0.750 g (0.00151 mol) of 1,1,2-tribromo-2-(2-benzenesulfonyloxyethyl)-cyclopropane in anhydrous N,N-dimethylformamide was added to the residue. After stirring at room temperature for 24 hours, the reaction mixture was poured onto water and extracted with ethyl acetate. The organic layer was dried over MgSO₄ and filtered. The solvent was removed from the filtrate in vacuo to yield 0.750 g of an oil which was subsequently purified by column chromatography with 0.5% to 1% diethyl ether/hexane-s to yield 0.500 g of 2-2-(4-chlorophenyl-thio)ethyl)-1,1,2-tribromocyclopropane as an oil.

f. 1-(2-(4-Chlorophenylthio)ethyl)cyclopropene

A solution of 0.500 g (0.0011 mol) of2-(2-(4-chlorophenylthio)ethyl)-1,1,2-tribromocyclopropane in 6 ml of diethyl ether was placed under a nitrogen atmosphere by use of a Firestone valve. While cooling in an ice water bath, 2.38 ml (0.00334 mol) of 1.4 M methyl lithium in diethyl ether was added slowly via syringe. After 15 minutes, 2 ml of water was added via syringe. The resulting mixture was transferred to a separatory funnel and the phases were separated. The organic layer was dried over MgSO₄ and filtered. The solvent was removed from the filtrate in vacuo with a bath temperature under 20° C. to yield 0.100 g of 1-(2-(4-chlorophenylthio)ethyl)cyclopropene as an oil.

### Example 10

### 2-(2-Benzenesulfonyloxvethyl)-cyclopropenb (Compound 10)

A solution of 0.745 g (0.00150 mol) of 1,1,2-tribromo-2-(2-benzenesulfonyloxyethyl)-cyclopropane in 4 ml of diethyl ether was placed under a nitrogen atmosphere by use of a Firestone valve. While cooling to −78° C. in a dry ice/acetone bath, 23.45 ml (0.00450 mol) of 1.4 M methyl lithium in diethyl ether was added slowly via syringe. After 15 minutes warmed to 0° C. in an ice water bath then returned to −78° C. for about 30 minutes before 2 ml of water was added via syringe. The resulting mixture was transferred to a separatory funnel and the phases were separated. The organic layer was dried over MgSO₄ and filtered. The solvent was removed from the filtrate in vacuo with a bath temperature under 20° C. to yield >0.155 g of 70% pure 2-(2-benzenesulfonyloxyethyl)-cyclopropene contaminated with 30% 1-(2-hydroxethyl)cyclopropene as an oil.

### Example 11

### Preparation of 2-(1-(4-Bromopyrazole))-1-ethylcyclopropene (Compound 11)

a. 2-Hydroxy-1-ethylcyclopropene

A solution of 1.15 g (3.6 mmol) of 1,1,2-tribromo-2-(2-hydroxethyl)cyclopropane, (preparation described above) in 40 ml of ether was cooled to −78° C. Methyllithium (1.4M, 10.3 ml, 14.4 mmol) was added. The reaction mixture was warmed to 5° C. and held for one half hour. The reaction was quenched with water and the phases were separated. The ether phase was washed with water, washed with brine, dried over magnesium sulfate and stripped. The crude product was immediately used in the next reaction.

b. 2-Methanesulfonyl-1-ethylcyclopropene

The crude product of the above reaction was dissolved in 5 ml of ether and cooled in an ice bath. Triethylamine (1 ml) was added, then 0.49 g of methanesulfonyl chloride (4.3 mmol) was added. The reaction mixture was stirred for 1 hour. Water and additional ether were added and the phases were separated. The ether phase was washed with water twice, washed with brine, dried over magnesium sulfate and stripped to give 380 mg of 2-methanesulfonyl-1-ethylcyclopropene as a pale yellow liquid.

c. 2-(1-(4-Bromopyrazole))-1-ethylcyclopropene

To a suspension of 60% sodium hydride (0.13 g, 3.3 mmol) in 5 ml of DMF is added 0.51 g of 4-bromopyrazole (3.5 mmol). The reaction was stirred for 15 minutes at room temperature, then cooled in an ice bath. 2-Methanesulfonyl-1-ethylcyclopropene (280 mg, 1.7 mmol) was added. The ice bath was removed, and the reaction was stirred at room temperature for 2 hours. Ether and water were added to the reaction mixture and the phases were separated. The aqueous phase was extracted with additional ether. The combined ether phases were washed with water three times, washed with brine, dried over magnesium sulfate and stripped. The product was chromatographed to give 30 mg of 72% pure 2-(1-(4-bromopyrazole))-1-ethylcyclopropene.

### Example 12

### Preparation of 7-(1-Imidazole)-1-heptylcyclopropene (Compound 12)

a. 1 -(1 -Ethoxyethoxy)-6-bromohexane

To a cooled solution of 80 mg of toluenesulfonic acid in 40 ml of ether was fed 20 g (110 mmol) of 6-bromohexanol and 40 ml of ethyl vinyl ether simultaneously by separate additional funnels. The temperature of the reaction mixture was kept at 7° C. or lower during the feeds, which took 1 hour. The reaction mixture was stirred 20 minutes longer, then roughly 1 ml of triethylamine was added. The reaction mixture was washed with water and brine, dried over potassium carbonate, filtered and stripped to give 25.7 g of a pale yellow liquid, which was used without further purification.

b. 9-(1-Ethoxyethoxy)-2-bromonon-1-ene

A slurry of 5.6 g of magnesium turnings (230 mmol) in 100 ml of THF was treated with a small amount of 1,2-dibromoethane. 1-(1-Ethoxyethoxy)-6-bromohexane (38.5 g, 152 mmol) was fed slowly to the reaction mixture, maintaining the temperature at 40-50° C. At the end of the addition the reaction mixture was held 20 minutes, then transferred by cannula to solution of 33.4 g (167 mmol) of 2,3-dibromopropene in 25 ml of THF at 0° C. The reaction mixture was stirred at 0° C. for 15 minutes, then stirred at room temperature for 15 minutes, then quenched with water. The reaction mixture was transferred into a separatory funnel. A small amount of 1 N HCl was added, the phases were separated, the ether phase was washed with water and brine, then dried over magnesium sulfate, filtered, and stripped to give 33.63 g of a yellow liquid which was used without further purification.

c. 1,1,2-Tribromo-2-(7-hydroxyheptyl)cyclopropane

A mixture of 9-(1-ethoxyethoxy)-2-bromonon-1-ene (33.63 g, 115 mmol), 4.1 g of N,N′-dibenzyl-N,N,N′,N′-tetraethylethylenediammonium dibromide, 42 g of 45% potassium hydroxide (337 mmol), 93 g of bromoform (368 mmol) and 280 g of methylene chloride were rapidly stirred at room temperature for two days. When the reaction stalled, the reaction mixture was transferred to a separatory funnel and washed with water. The methylene chloride phase was transferred to a flask and treated with the same amount of the phase transfer catalyst and 45% potassium hydroxide as above, then stirred at room temperature for an additional 3 days. The reaction mixture was washed with water, the methylene chloride phase was dried with magnesium sulfate, and then stripped. The product was treated with 320 ml of methanol and 40 ml of 1N HCl for 1 hour at room temperature. The methanol was stripped, ethyl acetate was added. The organic phase was washed with water and brine, then treated with 200 ml of silica gel. Filtration followed by a strip gave 38 g of black product. This was chromatographed on silica gel to give 19.0 g of 1,1,2-tribromo-2-(7-hydroxyheptyl)cyclopropane as a pale yellow liquid.

d. 1-(7-Hydroxyheptyl)-cyclopropene

A solution of 1.0 g 1,1,2-tribromo-2-(7-hydroxyheptyl)cyclopropane (2.5 mmol) in 25 ml of ether was treated at −78° C. with 7.2 ml of methyllithium (1.4 M, 10 mmol). After 5 minutes, the reaction mixture was warmed to 0° C. and held at this temperature. The reaction was quenched with saturated ammonium chloride. The reaction mixture was washed with water and brine, dried over magnesium sulfate, filtered and stripped to give 240 mg of 1-(7-hydroxyheptyl)-cyclopropene.

e. 1-(7-Methanesulfonyloxyheptyl)-cyclopropene

A solution of 3.8 mmol of 1-(7-hydroxyheptyl)-cyclopropene in 50 ml of ether was cooled in an ice bath. Triethylamine (1 ml) and 0.48 g of methanesulfonyl chloride (4.2 mmol) were added and the reaction mixture was stirred for 2½ hours at 0° C. The reaction mixture was washed with water and brine, dried over magnesium sulfate, filtered and stripped to give 1-(7-methanesulfonyloxyheptyl)-cyclopropene which was used without further purification.

f. 7-(1-Imidazole)-1-heptylcyclopropene

To a suspension of 60% sodium hydride (0.08g, 2 mmol) in 5 ml of DMF in an ice bath is added 0.14 g of imidazole (2 mmol). The reaction was stirred for 15 minutes, then 0.3 g (1.3 mmol) of 1-(7-methanesulfonyloxyheptyl)-cyclopropene in 3 ml of DMF was added. The reaction mixture was stirred for 10 minutes, then the ice bath was removed, and the reaction was stirred at room temperature for 1 hour. Ether and water were added to the reaction mixture and the phases were separated. The aqueous phase was extracted with additional ether. The combined ether phases were washed with water three times, washed with brine, dried over magnesium sulfate and stripped. The product was chromatographed to give 80 mg of 7-(l-imidazole)-1-heptylcyclopropene.

### Example 13

### Preparation of 7-(diphenylamino)-1-heptylcyclopropene (Compound 13)

Diphenylamine (0.42g, 2.5 mmol) in 10 ml of THF was cooled to −78° C. and treated with 1.6 ml (1.4M, 2.2 mmol) methyllithium. 1-(7-Methanesulfonyloxyheptyl)-cyclopropene was added, the bath was removed, and the reaction mixture was allowed to warm to room temperature. The reaction was held for 5.5 hours, then quenched with water. Ether and water were added to the reaction mixture and the phases were separated. The ether phase was washed with water twice, washed with brine, dried over magnesium sulfate and stripped. The product was chromatographed to give 80 mg of 7-(diphenylamino)-1-heptylcyclopropene as a colorless liquid.

### Example 14

### Preparation of 1-Cyclohexylcyclopropene (Compound 14)

1-Cyclohexyl-2-(trimethylsilyl)cyclopropanol was prepared from methyl cyclohexylcarboxylate and vinyltrimethylsilane as described in Mizojiri, R; Urabe, H.; Sato, F. J. Org Chem. 2000, 65, 6217. This material was converted to the cyclopropene in an analogous manner to that described in the same reference.

### Example 15

### Preparation of 1-((2-Carboxy-N-morpholino)ethyl)-cyclopropene

a. 2-(2-Bromo-allyl)-malonic Acid Diethyl Ester

The oil was removed from 21.70 g (0.542 mol) of 60% sodium hydride in oil by washing with hexanes. To the residue suspended in 200 ml tetrahydrofuran, 84.38 ml (0.556 mol) diethyl malonate was added slowly via addition funnel. While the reaction was cooled to −35 to −10° C., 100 g (0.400 mol) of 2,3-dibromopropene was added slowly via addition funnel. After heating to reflux for 1 hour, the reaction was cooled to room temperature and concentrated in vacuo. Hexanes and water were added to the residue and the resulting mixture was transferred to a separatory funnel where the phases were separated. The isolated organic layer was washed with 1N hydrochloric acid then dried over magnesium sulfate and filtered. The solvent was removed from the filtrate in vacuo to yield 154 g of 2-(2-bromo-allyl)-malonic acid diethyl ester as an oil.

b. 2-(2-Bromo-allyl)-malonic Acid

A mixture of 10.5 g (0.0376 mol) of 2-(2-bromo-allyl)-malonic acid diethyl ester and 37.6 ml (0.470 mol) of 50% aqueous sodium hydroxide was stirred at room temperature for 4 days. The reaction mixture was extracted with diethyl ether. The isolated aqueous layer was acidified by the addition of concentrated hydrochloric acid and diethyl ether was added. The resulting mixture was transferred to a separatory funnel where the phases were separated. The isolated organic layer dried over magnesium sulfate and filtered. The solvent was removed from the filtrate in vacuo to yield 5.3 g of 2-(2-bromo-allyl)-malonic acid as a solid which was carried on without purification.

c. 4-Bromo-pent4-enoic Acid

5.3 g (0.0238 mol) of neat, unpurified 2-(2-bromo-allyl)-malonic acid was heated to 125-130° C. for 8 hours to yield 3.73 g of 4-bromo-pent4-enoic acid which was carried on without purification.

d. 4-Bromo-pent4-enoic Acid Ethyl Ester

To a solution of 3.73 g (0.0208 mol) of unpurified 4-bromo-pent4-enoic acid in 3 ml chloroform with I drop of N,N-dimethylformamide was added 1.18 ml (0.0162 mol) of thionyl chloride. After this mixture had been heated to 60° C. for 30 minutes, it was added to a solution of 2.46 ml (0.0436 mol) ethanol and 1.97 ml (0.024 mol) pyridine and 13 ml methylene chloride. After stirring for 30 minutes, the reaction mixture was concentrated in vacuo. To the residue was added diethyl ether and water. The resulting mixture was transferred to a separatory funnel where the phases were separated. The isolated organic layer was dried over magnesium sulfate and filtered. The solvent was removed from the filtrate in vacuo to yield 3.5 g of 4-bromo-pent-4-enoic acid ethyl ester as an oil which was purified via vacuum distillation.

e. 1,1,2-Tribromo-2-((3-carboethoxy)ethyl)-cyclopropane

1,1,2-Tribromo-2-((3-carboethoxy)ethyl-cyclopropane was prepared in a manner similar to that described for the corresponding intermediate in Example 9.

The residue obtained was purified by column chromatography with diethyl ether/hexanes.

f. 1,1,2-Tribromo-2-((2-carboxy)ethyl)-cyclopropane

After a solution of 10.2 g (0.0269 mol) of 1,1,2-tribromo-2-((3-carboethoxy)-ethyl)cyclopropane in 40 ml (0.736 mol) of 48% hydrobromic acid and 40 ml of water was heated to reflux for 8 hours, it was cooled to room temperature and then Va-cuum filtered through Shark Skin® filter paper. The isolated solid was washed with water before adding diethyl ether. The solution was transferred to a separatory funnel where it was washed with saturated aqueous sodium bicarbonate which was isolated and made acidic by the addition of 1N hydrochloric acid. The aqueous solution was returned to a separatory funnel and extracted with diethyl ether. The isolated organic layer was dried over magnesium sulfate and filtered. The solvent was removed from the filtrate in vacuo to yield 5.9 g of 1,1,2-tribromo-2-((2-carboxy))-ethylcyclopropane as a solid which was used as is.

g. 1,1,2-Tribromo-2-((2-carboxy-N-morpholino)ethyl)-cyclopropane

To a slurry of 0.97 g (0.00276 mol) of 1,1,2-tribromo-2-((2-carboxy))-ethyl-cyclopropane in 2 ml of chloroform were added 1 drop of N,N-dimethylformamide and 0.434 ml (0.00596 mol) of thionyl chloride. After 15 minutes of heating toireflux, the reaction mixture was concentrated in vacuo. A solution of this residue in 2 ml of methylene chloride was added to a solution of 0.486 ml (0.00552 mol) of morpholine in 1 ml of methylene chloride being cooled to −20° C. After 30 minutes the reaction mixture was concentrated in vacuo. The resulting residue was extracted from a minimal amount of 1N hydrochloric acid with ethyl acetate. The organic layer was dried over MgSO₄ and filtered. The solvent was removed from the filtrate in vacuo to yield 1.08 g of 1,1,2-tribromo-2-((2-carboxy-N-morpholino)ethyl)-cyclopropane as an oil.

h. 1-((2-Carboxy-N-morpholino)ethyl)-cyclopropene

0.460 g of 60% pure 1-((2-carboxy-N-morpholino)ethyl)-cyclopropene was prepared in a manner similar to compound 1.

3-Hydroxycarbonylmethyl-1,2,3-triphenylcyclopropene (Compound 40) is commercially available.

### Example 16

### Preparation of 1-(7-(N-piperidinoimino-heptyl))-cyclopropene (Compound 36)

a. 1-(7-(Heptanal))-cyclopropene

1-(7-Hydroxyheptyl)-cyclopropene (preparation given in example 12) was oxidized to 1-(7-(heptanal))-cyclopropene using a Swern oxidation by the method described in Arrowood, T. L.; Kass, S. R. Tetrahedron, 1999, 55, 6739-48.

b. 1-(7-(N-piperidinoimino-heptyl))-cyclopropene

To a solution of 100 mg of 1-(7-(heptanal))-cyclopropene (0.66 mmol) in ethanol was added 70 mg (0.70 mmol) of N-aminopiperidine. The reaction mixture was stirred for 2 hours, then ether, water and a few drops of acetic acid were added. The aqueous phase was separated, and the ether phase was washed with water and brine, then dried over magnesium sulfate and filtered. The solvent was stripped to give 70 mg of 1-(7-(N-piperidinoimino-heptyl))-cyclopropene.

### Example 17

### Preparation of 1-(3-trifluoromethylphenoxymethyl)-2-ethylcyclopropene (Compound 37)

a. 1,1,2-Tribromo-2-ethylcyclopropane

1,1,2-Tribromo-2-ethylcyclopropane was prepared from 2-bromo-1-butene by the same method used in example 4 c.

b. 1-(Hydroxymethyl)-2-ethylcyclopropene

A solution of 3.0 g (10 mmol) of 1,1,2-tribromo-2-ethylcyclopropane in 50 ml of ether was co9oled to −78° C. Methyllithium (1.4M, 21.4 ml, 30 mmol) was added. The reaction mixture was warmed to 5° C. Solid paraformaldehyde (1.20 g, 40 mmol) was added, and the reaction mixture was stirred at 5° C. for 1 hour, then allowed to warm to room temperature and stirred an additional hour. The reaction was quenched with water and the phases were separated. The ether phase was washed with water, washed with brine, dried over magnesium sulfate and stripped to give 900 mg of 1-(hydroxymethyl)-2-ethylcyclopropene as a yellow oil.

c. 1-(Methanesulfonyloxymethyl)-2-ethylcyclopropene

To a solution of 0.70g (7.13 mmol) of 1-(hydroxymethyl)-2-ethylcyclopropene (Compound 3) and 2 ml of triethylamine in 15 ml of ether in an ice bath, was added 0.86 g (7.5 mmol) of methanesulfonyl chloride. The reaction mixture was held 1.5 hours, then quenched with water. The phases were separated. The ether phase was washed with water, washed with brine, dried over magnesium sulfate and stripped to give 840 mg of 1-(methanesulfonyloxymethyl)-2-ethylcyclopropene as a yellow oil.

d. 1-(3-trifluoromethylphenoxymethyl)-2-ethylcyclopropene

3-Trifluoromethylphenol (0.41 g, 2.5 mmol) was added to a suspension of 0.07 g of sodium hydride (1.8 mmol) in 3 ml of DMF at room temperature. After 15 minutes, a solution of 0.3 g (1.7 mmol) of 1-(methanesulfonyloxymethyl)-2-ethylcyclopropene in 2 ml of DMF was added, and the reaction mixture was stirred for 2 hours. Ethyl acetate and water were added. The phases were separated, and the ethyl acetate phase was washed with 1 N aqueous sodium hydroxide and brine, then dried over magnesium sulfate, filtered, and stripped to give 160 mg of 1-(3-trifluoromethylphenoxymethyl)-2-ethylcyclopropene as a tan liquid.

### Example 18

### Preparation of 2-Octyl-1-(2-(2-boro-1,3dioxetane))-cyclopropene (Compound 38)

a. 2-Octyl-1-(boronic acid)-cyclopropene

An ethereal solution of 1.30 g (3.3 mmol) of 2-octyl-1,1,2-tribromocyclopropane, prepared in the same manner as described in example 1 was cooled to −78° C. Methyllithium (1.4M, 5.9 ml, 8.3 mmol) was added, and the reaction mixture was stirred for 10 min, then placed in an ice bath and held for 30 minutes, then recooled to −78° C. Triisopropylborate (0.9 ml, 3.9 mmol) was added, and the reaction mixture was stirred for 15 minutes, then warmed to 0° C. Water, ether and 1N aqueous HCl (enough to make the solution acidic) were added. The phases were separated. The ether phase was washed with water, washed with brine, dried over magnesium sulfate and stripped. The product was redissolved in ether and extracted three times with 1N aqueous sodium hydroxide solution. The aqueous extracts were acidified with 6N aqueous hydrochloric acid and extracted three times with ether. The ether phase was washed with water, washed with brine, dried over magnesium sulfate and stripped to give 400 mg of pale yellow solid 2-octyl-1-(boronic acid)-cyclopropene.

b. 2-Octyl-1-(2-(2-boro-1,3dioxetane))-cyclopropene

A mixture of 270 mg of 2-octyl-1-(boronic acid)-cyclopropene (1.4 mmol) in 10 ml of pentane was treated with 0.3 ml of 1,3-dihydroxypropane at room temperature. After 1.5 h, the reaction mixture was transferred to a separatory funnel. The pentane solution was washed with water and brine, dried over magnesium sulfate, filtered and stripped to give 90 mg of 50% pure 2-octyl-1-(2-(2-boro- 1,3dioxetane)) -cyclopropene.

NMR predicted: 0.88 (t, 3H), 0.98 (s, 2H), 1.1-1.3 (m, 10H), 1.55 (m, 2m), 1.9 (m, 2H), 2.5 (m, 2H), 4.1-4.4 (m, 4H)

### Example 19

### Preparation of 1-Methyl-2-(hydroxy(3-methoxyphenyl)methyl)cyclopropene (Compound 39)

To a mixture of about 2 mg 1,10-phenanthroline in 50 ml diethylether under nitrogen and kept in a −40° C. bath was added sequentially via syringe diisopropylamine (2.5 ml, 17.9 mmol), diethylether (3 ml), 1-methylcyclopropene (1.1 g, 20.4 mmol; prepared from 3-chloro-2-methyl-propene see Hopf, H. et al. Chem. Ber. 1985, 118,:3579 and Kbster, R. et al. Liebigs Annalen Chem. 1973, 1219-1235.) Then 1.0 ml N-butyllithium (1.6M in hexane) was added until a brown color remained. This was followed by another portion of the same butyllithium (10.0 ml, 16 mmol.) After stirring at −40° C. for 15 minutes, the reaction was cooled to −70° C. and 3-methoxybenzaldehyde (1.9 ml, 15.6 mmol) was added. After 3 minutes, the reaction was quenched by the addition of 3 ml water. After warming to room temperature, the layers were separated. The organic phase was dried over magnesium sulfate and dried in vacuo. This residue was dissolved in diethylether and washed with 1M hydrochloric acid, brine and finally saturated aqueous sodium bicarbonate. The layers were separated. The organic phase was dried over magnesium sulfate and dried in vacuo to yield 1.0 g of 1-methyl-2-(hydroxy(3-methoxyphenyl)methyl)cyclopropene.

### Example 20

### 1-Phenyl-2,3,3-trichlorocyclopropene (Compound 41)

1-Phenyl-2,3,3-trichlorocyclopropene was prepared by the method described in Eicher, theophil; Huch, Volker; Schneider, Volker; Veith, Michael. Synthesis, 1989, 5, 367-72.

### Example 21

### 1-(4-Methylphenylcarbonyloxybutyl)•cyclolrolene (Compound 44)

a. 5,6-Dibromo-hexan-1-ol

To an ice bath cooled solution of 5-hexen-1-ol (11.23 g, 112.3 mmol) in about 20 ml methylene chloride was added bromine (5.80 ml plus 12 drops, 112.3+mmol) in about 20 ml methylene chloride. At the completion of the addition, the mixture is dried in vacuo to yield 29.1 g of 5,6-dibromo-hexan-1-ol.

b. 5-Bromo-hex-5-en-1-ol

To an ice bath cooled solution of 5,6-dibromo-hexan-1-ol (29.1 g, 112 mmol) in about 59 ml tetrahydrofuran was added 20% potassium t-butoxide in tetrahydrofuran (62.4g, 112 mmol.) At the completion of the addition the reaction was warmed to room temperature and stirred for about 30 minutes. Diethyl ether and water were added then the phases were separated. The isolated organic layer was dried over magnesium sulfate then dried in vacuo. This residue was purified by vacuum distillation using a 5 perforated plate column to yield 23.16 g of 87% pure 5-bromo-hex-5-en-1-ol.

c. 4-Methyl-benzoic Acid 5-bromo-hex-5-enyl Ester

To a solution of 5-bromo-hex-5-en-1-ol (4.39 g, 24.5 mmol) in 10.6 g methylene chloride were added 4-toluoylchloride (3.95 g, 25.6 mmol) and triethylamine (3.3 g, 33 mmol.) After stirring about 2 hours at room temperature, the mixture was diluted with diethylether then washed with 1 N hydrochloric acid followed by brine. The phases were separated and the organic layer dried over magnesium sulfate then dried in vacuo to yield 7.3 g of 4-methyl-benzoic acid 5-bromo-hex-5-enyl ester.

d. 4-Methyl-benzoic acid 4-(1,2,2-tribromo-cyclopropyl)-butyl ester 4-Methyl-benzoic acid 5-bromo-hex-5-enyl ester (7.3 g, 24.6 mmol), N,N′-dibenzyl-N, N, N′,N′-tetramethylethylenediammonium dibromide (0.30 g, 0.66 mmol), methylene chloride (25 g), bromoform (25 g, 98.9 mmol) and 45% aqueous potassium hydroxide (11.5 g, 92 mmol) were charged to a round bottomed flask and stirred at room temperature for 4 days. After water was added, the layers were separated. To the isolated organic layer was added N,N′-dibenzyl-N, N, N′,N′-tetramethylethylenediammonium dibromide (0.30 g, 0.66 mmol), bromoform (27 g, 107 mmol) and 45% aqueous potassium hydroxide (12 g, 96 mmol.) After stirring at room temperature for an additional day, water and hexanes were added. The mixture was gravity filtered through qualitative filter paper and the layers were separated. The isolated organic layer was dried over magnesium sulfate then dried in vacuo. This residue was purified by column chromatography using ethyl acetate/hexanes to give 4.9 g of 61% pure 4-methyl-benzoic acid 4-(1,2,2-tribromo-cyclopropyl)-butyl ester.

e. 4-(1,2,2-Tribromo-cyclopropyl)-butan-1-ol

To a solution of 4-methyl-benzoic acid 4-(1,2,2-tribromo-cyclopropyl)-butyl ester (45.5 g, 97 mmod) in 250 g of methanol was added 50% aqueous potassium carbonate (30 g, 107 mmol) and 30 g water. The reaction was heated to 60° C. for about 2 hours then cooled to room temperature. After about 15 hours, 50% aqueous potassium carbonate (30 g, 107 mmod) and 30 g water were added and the reaction was heated to 60° C. for about 2 hours then cooled to room temperature. The reaction mixture was concentrated in vacua, then the resulting residue was extracted with diethyl ether. The organic layer was washed with basified water (pH10.) The phases were separated and the organic phase was dried over magnesium sulfate then dried in vacuo. This residue was purified by column chromatography using diethyl etherthexanes to give 14.5 g of 74% pure 4-(1,2,2-tribromo-cyclopropyl)-butan-1-ol.

f. 1-(4-Hydroxybutyl)-cyclopropene

A solution of 4-(1,2,2-tribromo-cyclopropyl)-butan-1-ol (5.11 g, 14.5mmol) in 4 ml of diethylether was placed under a nitrogen atmosphere and cooled to 0° C. Using a syringe, 1.4 M methyllithium in diethylether (41.6 ml, 58.2 mmol) was added. After 15 minutes, the reaction was quenched by the addition of about 2 ml water. The phases were separated. The isolated organic layer was dried over magnesium sulfate and dried in vacuo to yield 2.51 g of 1-(4-hydroxybutyl)-cyclopropene as an oil.

g. 1-(4-Methylphenylcarbonyloxybutyl)-cyclopropene

A solution of 1-(4-hydroxybutyl)-cyclopropene (810 mg, 7.23 mmol) in 5-10 ml methylene chloride was cooled to 0° C. To this were added triethylamine (0.895 ml, 7.88 mmol) followed by 4-toluoylchloride (0.794 ml, 7.30 mmol.) After stirring at about 10 IC for 1 hour, the reaction was cooled to 0° C. and triethylamine (0.895 ml, 7.88 mmol) followed by 4-toluoylchloride (0.794 ml, 7.30 mmol) were added. After stirring for about an hour at room temperature, the reaction mixture was concentrated in vacuo. To this residue were added diethylether and water. The phases were separated. The isolated organic layer was washed with 1N hydrochloric acid, then dried over magnesium sulfate and dried in vacuo to yield 2.05 g of an oil. This was purified by column chromatography on silica gel using ethyl acetate/hexanes to give 470 mg of 50% pure 1-(4-methylphenylcarbonyloxybutyl)-cyclopropene with the remainer p-toluic acid.

### Example 22

### 1-Benzyl-2-bromocyclopropene (Compound 45)

a. 1-Benzyl- 1,2,2-tribromocyclopropane

1-Benzyl-1,2,2-tribromocyclopropane was prepared from 1-(2-bromo-allyl)-benzene by the method shown in Example 1b.

b. 1-Benzyl-2-bromocyclopropene

Mixed 1-benzyl-1,2,2-tribromocyclopropane(1.21 g, 3.27 mmol) and diethylphosphite (1.69 ml, 13.1 mmol) and triethylamine (0.455 ml, 3.26 mmol) at room temperature for 24 hours. To the reaction mixture was added hexanes, which was washed with 1N hydrochloric acid. The phases were separated. The aqueous layer was extracted with diethylether and these phases were separated. The combined organic layers were purified via column chromatography on silica gel using diethyletherthexanes to give 300 mg of 1-benz yl-2-bromocyclopropene as an oil.

### Example 23

### 1-Benzyl-2-chlorocyclopropene (Compound 46)

a. 1-(2-Bromo-allyl)-benzene

1-(2-Bromo-allyl)-benzene was prepared from 2,3-dibromopropene and phenylmagnesium bromide by the method shown in Example 1a.

b. 1-Benzyl-1-bromo-2,2-dichlorocyclopropane

To a solution of 1-(2-bromo-allyl)-benzene (6.80 g, 34.5 mmol) in chloroform (39.4 ml, 493 mmol) were added 45% aqueous potassium hydroxide (16.2 ml, 189 mmol) and N,N′-dibenzyl-N, N, N′,N′-tetramethylethylenediammonium dibromide (790 mg, 1.72 mmol.) After stirring for 3 days at room temperature, chloroform (2 ml) and 45% aqueous potassium hydroxide (16.2ml, 189 mmol) and N,N′-dibenzyl-N, N, N′,N′-tetramethylethylenediammonium dibromide (790 mg, 1.72 mmol) were added. After stirring for an additional day at room temperature, hexanes and water were added. The phases were separated. The isolated organic layer was dried over magnesium sulfate and dried in vacuo to give 6.7 g of 1-benzyl-1-bromo-2,2-dichlorocyclopropane as an oil.

c. 1-Benzyl-2-chlorocyclopropene

A solution of 1-benzyl-1-bromo-2,2-dichlorocyclopropane (1.45 g, 5.18 mmol) in about 4 ml diethylether was cooled to 0° C. and placed under a nitrogen atmosphere. To this was added 1.4 M methyllithium in diethyl ether (3.70 ml, 5.18 mmol.) After 15 minutes the reaction was quenched by the addition of 2 ml water. The phases were separated. The The isolated organic layer was dried over magnesium sulfate and dried in vacuo to yield 720 mg of 1-benzyl-2-chlorocyclopropene as an oil.

### Example 24

### Preparation of 1-(2-(Furan-2-ylcarbonyloxyethyl)-cyclopropene (Compound 47)

a. 2-Bromo-4-(1-ethoxy-ethoxy)-but-1-ene

While cooling a solution of 10.38 g (0.0687 mol) of commercially available 3-bromo-3-buten-1-ol in 20 ml of diethyl ether with 50 mg (0.000263 mol) p-toluene sulfonic acid monohydrate in an ice water bath, 19 ml (0.199 mol) of ethyl vinyl ether was added slowly dropwise to maintain an internal temperature of <10° C. After I hour at 0° C., a few drops of triethylamine was added. The reaction mixture was poured onto water. The resulting mixture was transferred to a separatory funnel and the phases were separated. The isolated organic layer was washed with brine then dried over potassium carbonate and filtered. The solvent was removed from the filtrate in vacuo to yield 14.04 g of 2-bromo-4-(1-ethoxy-ethoxy)-but-1-ene as an oil.

b. 1,1,2-Tribromo-2-[2-(1-ethoxy-ethoxy)-ethyl]-cyclopropane

To a solution of 14.02 g (0.0628 mol) 2-bromo-4-(1-ethoxy-ethoxy)-but-1-ene in 108 ml methylene chloride with 0.5-0.9 ml 45% aqueous potassium hydroxide was added 16.4 ml (0.118 mol) of bromoform and 2.88 g (0.00628 mol) of N,N′-dibenzyl-N,N,N′,N′-tetramethylethylenediammonium dibromide and 28 ml (0.314 mol) 45% aqueous potassium hydroxide. After 3 days the reaction mixture was poured onto water. The resulting mixture was transferred to a separatory funnel and the phases were separated. To the isolated organic layer was added 2.88 g (0.00628 mol) of N,N-dibenzyl-N,N,N′,N′-tetramethylethylenediammonium dibromide and 28 ml (0.314 mol) 45% aqueous potassium hydroxide. After 24 hours, there was added hexanes and water. This mixture was gravity filtered through qualitative fluted filter paper. The resulting mixture was transferred to a separatory funnel and the phases were separated. The organic layer was dried over MgSO₄ and filtered. The solvent was removed from the filtrate in vacuo to yield 17.0 g of 1,1,2-tribromo-2-[2-(1-ethoxy-ethoxy)-ethyl]-cyclopropane as an oil.

c. 2-(2-Hydroxyethyl)-1,1,2-tribromocyclopropane

To a slurry of 16.5 g (0.0418 mol) of 1,1,2-tribromo-2-[2-(1-ethoxy-ethoxy)-ethyl]-cyclopropane in 145 ml methanol and 40 ml water, was added 0.306 g (0.00161 mol) p-toluene sulfonic acid monohydrate and 145 ml 6M hydrochloric acid. After stirring at room temperature for 1 hour, the solvent was removed from the reaction mixture in vacuo. To the residue, there was added ethyl acetate and water. The resulting mixture was transferred to a separatory funnel and the phases were separated. The isolated organic layer was washed with brine then dried over MgSO₄ and filtered. The solvent was removed from the filtrate in vacuo to yield 11.9 g of 2-(2-hydroxyethyl)-1,1,2-tribromocyclopropane as an oil.

d. 1-(2-Hydroxyethyl)-cyclopropene

A solution of 1.15 g (3.6 mmol) of 2-(2-hydroxyethyl)-1,1,2-tribromocyclopropane, (preparation described above) in 40 ml of ether was cooled to −78° C. Methyllithium (1.4M, 10.3 ml, 14.4 mmol) was added. The reaction mixture was warmed to 5° C. and held for one half hour. The reaction was quenched with water and the phases were separated. The ether phase was washed with water, washed with brine, dried over magnesium sulfate and stripped. The crude product was immediately used in the next reaction.

e) 1-(2-(Furan-2-ylcarbonyloxyethyl)-cyclopropene

To a 0° C. solution of 1-(2-hydroxyethyl)-cyclopropene (300 mg, 3.56 mmol) in about 10 ml methylene chloride were added triethylamine (0.540 ml, 3.88 mmol) and furan-2-carbonyl chloride (0.356 ml, 3.60 mmol.) After stirring at room temperature for about 2 hours, the reaction mixture was concentrated in vacuo. To this residue was added diethylether and water. The phases were separated. The organic layer was washed with 1N hydrochloric acid. After the phases were separated, the organic layer was dried over magnesium sulfate and dried in vacuo to give 430 mg of an oil. This was purified by column chromatography on silica gel using diethylether/hexanes to yield 20 mg of 1-(2-(Furan-2-ylcarbonyloxyethyl)-cyclopropene as an oil.

### Example 25

### Preparation of 1-(7-(4-Methanesulfonyloxyphenyl)-carbonyloxyheptyl)-cyclopropene (Compound 53)

a. 1-(1-Ethoxyethoxy)-6-bromohexane

To a cooled solution of 80 mg of toluenesulfonic acid in 40 ml of ether was fed 20 g (110 mmol) of 6-bromohexanol and 40 ml of ethyl vinyl ether simultaneously by separate additional funnels. The temperature of the reaction mixture was kept at 7° C. or lower during the feeds, which took 1 hour. The reaction mixture was stirred 20 minutes longer, then roughly 1 ml of triethylamine was added. The reaction mixture was washed with water and brine, dried over potassium carbonate, filtered and stripped to give 25.7 g of a pale yellow liquid, which was used without further purification.

b. 9-(1-Ethoxyethoxy)-2-bromonon-1-ene

A slurry of 5.6 g of magnesium turnings (230 mmol) in 100 ml of THF was treated with a small amount of 1,2-dibromoethane. 1-(1-Ethoxyethoxy)-6-bromohexane (38.5 g, 152 mmol) was fed slowly to the reaction mixture, maintaining the temperature at 40-50° C. At the end of the addition the reaction mixture was held 20 minutes, then transferred by cannula to solution of 33.4 g (167 mmol) of 2,3-dibromopropene in 25 ml of THF at 0° C. The reaction mixture was stirred at 0° C. for 15 minutes, then stirred at room temperature for 15 minutes, then quenched with water. The reaction mixture was transferred into a separatory funnel. A small amount of 1 N HCl was added, the phases were separated, the ether phase was washed with water and brine, then dried over magnesium sulfate, filtered, and stripped to give 33.63 g of a yellow liquid which was used without further purification.

c. 1,1,2-Tribromo-2-(7-hydroxyheptyl)cyclopropane

A mixture of 9-(1-ethoxyethoxy)-2-bromonon-1-ene (33.63 g, 115 mmol), 4.1 g of N,N′-dibenzyl-N,N,N′,N′-tetraethylethylenediammonium dibromide, 42 g of 45% potassium hydroxide (337 mmol), 93 g of bromoform (368 mmol) and 280 g of methylene chloride were rapidly stirred at room temperature for two days. When the reaction stalled, the reaction mixture was transferred to a separatory funnel and washed with water. The methylene chloride phase was transferred to a flask and treated with the same amount of the phase transfer catalyst and 45% potassium hydroxide as before, then stirred at room temperature for an additional 3 days. The reaction mixture was washed with water, the methylene chloride phase was dried with magnesium sulfate, and then stripped. The product was treated with 320 ml of methanol and 40 ml of 1N HCl for 1 hour at room temperature. The methanol was stripped, ethyl acetate was added. The organic phase was washed with water and brine, then treated with 200 ml of silica gel. Filtration followed by a strip gave 38 g of black product. This was chromatographed on silica gel to give 19.0 g of 1,1,2-tribromo-2-(7-hydroxyheptyl)cyclopropane as a pale yellow liquid.

d. 1-(7-Hydroxyheptyl)-cyclopropene

A solution of 1.0 g 1,1,2-tribromo-2-(7-hydroxyheptyl)cyclopropane (2.5 mmol) in 25 ml of ether was treated at −78° C. with 7.2 ml of methyllithium (1.4 M, 10 mmol). After 5 minutes, the reaction mixture was warmed to 0° C. and held at this temperature. The reaction was quenched with saturated ammonium chloride. The reaction mixture was washed with water and brine, dried over magnesium sulfate, filtered and stripped to give 240 mg of 1-(7-hydroxyheptyl)-cyclopropene. e. 1-(7-(4-Methanesulfonyloxyphenyl)carbonyloxyheptyl)-cyclopropene

To a 15° C. solution of 1-(7-hydroxyheptyl)-cyclopropene (537 mg, 3.47 mmol) and 4-methylsulfonyl benzoic acid (764 mg, 3.82 mmol) and N,N-dimethylaminopyridine (42.1 mg, 0.347 mmol) and p-toluenesulfonic acid monohydrate (33.0 mg, 0.173 mmol) in about 30 ml methylene chloride is added a solution of N,N′-dicyclohexylcarbodiimide (85.8 mg, 4.16 mmol) in about 10 ml of methylene chloride. After stirring at room temperature about 90 minutes, the reaction mixture was vacuum filtered through extremely retentive filter paper. Water was added to this filtrate and the mixture stirred about 30 minutes. After the phases were separated, the organic layer was dried over magnesium sulfate and dried in vacuo to give 1.5 g of 70% pure 1-(7-(4-methanesulfonyloxyphenyl)-carbonyloxyheptyl)-cyclopropene.

### Example 26

### 1-(2-Pyridylthiopropyl)-cyclopropene (Compound 55)

a. Ethyl 4-bromopent-4-enoate

Ethyl 4-bromopent-4-enoate was prepared by the method described in Mori, M.; et al. Journal of Organtic Chemistry, 1983, 48, 4058-4067.

b. 3-(1,2,2-Tribromo-cyclopropyl)-propionic Acid Ethyl Ester

To a solution of ethyl 4-bromopent-4-enoate (24.24 g, 11.7 mmol) in 148 ml methylene chloride were added bromoform (35.3 ml, 35.1 mmol), N,N′-dibenzyl-N,N,N′,N′-tetramethylethylenediammonium dibromide (4.40 g, 1.17 mmol) and 45% aqueous potassium hydroxide (54.2 ml, 58.5 mmol.) After stirring at room temperature for 3 days, water was added, the layers were separated. To the isolated organic layer was added bromoform (35.3 ml, 35.1 mmol), N,N′-dibenzyl-N, N, N′,N′-tetramethylethylenediammonium dibromide (4.40 g, 1.17 mmol) and 45% aqueous potassium hydroxide (54.2 ml, 58.5 mmol.) After stirring at room temperature for an additional 3 days, water and hexanes were added. The mixture was gravity filtered through qualitative filter paper and the layers were separated. The isolated organic layer was dried over magnesium sulfate then dried in vacuo. This residue was purified by column chromatography on silica gel using diethyl ether/hexanes to give 20.5 g of 3-(1,2,2-tribromo-cyclopropyl)-propionic acid ethyl ester as an oil.

c. 3-(1,2,2-Tribromo-cyclopropyl)-propionic Acid

A solution of 3-(1,2,2-tribromo-cyclopropyl)-propionic acid ethyl ester (20.5 g, 54.0 mmol) in about 80 ml water and 80 ml hydrobromic acid was heated to reflux. After about 4 hours, the reaction was cooled to room temperature and diethyl ether was added. The phases were separated. The isolated organic layer was washed with dilute aqueous sodium hydroxide enough to be basic by pH test paper. The phases were separated and the aqueous layer was acidified by the addition of dilute hydrochloric acid. Diethyl ether was added to this aqueous layer. The phases were separated. The isolated organic layer was dried over magnesium sulfate and concentrated in vacuo. This residue was triturated with hexanes and then diethyl ether to give 3.23 g of 3-(1,2,2-tribromo-cyclopropyl)-propionic acid as a solid.

d. 1-(3-Hydroxypropyl)-1,2,2-tribromocyclopropane

A solution of 3-(1,2,2-tribromo-cyclopropyl)-propionic acid (850 mg, 2.42 mmol) in about 1 ml tetrahydrofuran was cooled-to −10° C. To this 1 M borane in tetrahydrofuran (1.97 ml, 1.96 mmol) was added slowly dropwise. After stirring overnight at room temperature, about 1 ml of a one to one mixture of glacial acetic acid and water was added. This mixture was concentrated in vacuo. The resulting residue was poured onto ice in 10 ml saturated aqueous sodium bicarbonate. Ethyl acetate was added and the phases were separated and this was repeated. The isolated organic layer was dried over magnesium sulfate then was concentrated in vacuo. This residue was dissolved in diethyl ether and washed two times with saturated aqueous sodium bicarbonate. The phases were separated and the isolated organic layer was dried over magnesium sulfate then was concentrated in vacuo to yield 540 mg of 1-(3-hydroxypropyl)-1,2,2-tribromocyclopropane as an oil.

e. 1-(3-Benzenesulfonyloxypropyl)-1,2,2-tribromo-cyclopropane

To a 0° C. cooled solution of 1-(3-hydroxypropyl)-1,2,2-tribromocyclopropane (540 mg, 1.60 mmol) in about 3 ml methylene chloride were added pyridine (0.155 ml, 1.92 mmol) and benzenesulfonyl chloride (0.203 ml, 1.60 mmol.) After stirring at room temperature for 3 days, water was added and the phases were separated. The isolated organic layer was dried over magnesium sulfate and concentrated in vacuo. This residue was dissolved in diethyl ether and washed with iN hydrochloric acid. The phases were separated and the isolated organic layer was dried over magnesium sulfate and concentrated in vacuo to yield 500 mg of 1-(3-benzenesulfonyloxypropyl)-1,2,2-tribromo-cyclopropane as an oil.

f. 1-(2-Pyridylthiopropyl)-1,2,2-tribromo-cyclopropane

To a solution of 2-mercaptopyridine (0.117 g, 1.04 mmol) in about 3 ml methanol was added 25% sodium methoxide in methanol (0.239 ml, 1.04 mmol.) After stirring for an hour at room temperature, the reaction mixture was concentrated in vacuo. To this residue dissolved in 3 ml N,N-dimethylformamide was added a solution of 1-(3-benzenesulfonyloxypropyl)-1,2,2-tribromo-cyclopropane (500 mg, 1.04 mmol) in 3 ml N,N-dimethylformamide. After stirring at room temperature for 16 hours, water and diethyl ether were added and the phases were separated. The isolated organic layer was dried over magnesium sulfate and concentrated in vacuo. This residue was purified by column chromatography on silica gel using ethyl acetate/hexanes to give 200 mg of 1-(2-pyridylthiopropyl)-1,2,2-tribromo-cyclopropane as an oil.

g. 1-(2-Pyridylthiopropyl)-cyclopropene

A solution of 1-(2-pyridylthiopropyl)-1,2,2-tribromo-cyclopropane (200 mg, 0.465 mmol) in 2 ml diethyl ether was cooled to 0° C. and put under a nitrogen atmosphere. To this solution was added 1.4 M methyllithium (1.00 ml, 1.39 mmol.) After 15 minutes, the reaction was quenched by the addition of 1 ml water. The phases were separated and the isolated organic layer was dried over magnesium sulfate and then concentrated in uacuo to give 50 mg of 1-(2-pyridylthiopropyl)-cyclopropene as an oil.

### Example 27

### 1-(8-Benzenesulfonyloxyoctyl)-cyclopropene (Compound 56)

a. 9,10-Dibromo-decan- 1-ol

To a solution of dec-9-en-1-ol (40.34 g, 0.258 mol) in about 70 ml of methylene chloride which was cooled in an ice/brine bath was added a solution of bromine (13.3 ml, 0.258 mol) in about 20 ml methylene chloride. After stirring at room temperature for about 15 minutes, the reaction was concentrated in vacuo to give 9,10-dibromo-decan-1-ol as an oil which was used without further purification.

b. 9-Bromo-dec-9-en-1-ol

To a solution of 9,10-dibromo-decan-1-ol (81.7 g, 0.258 mol) in about 140 ml tetrahydrofuran which was cooled in an ice bath was added a 20% solution of potassium t-butoxide in tetrahydrofuran (24.8 g, 0.258 mol.) After stirring at about 5° C. for about 10 minutes and stirring at room temperature for about 15 minutes, the reaction mixture was concentrated in vacuo. To this residue was added water and diethyl ether. The phases were separated. The isolated organic layer was dried over magnesium sulfate and then concentrated in vacuo to give 66.1 g of an oil. This was purified via vacuum distillation to yield 35.3 goof about 66% pure 9-bromo-dec-9-en-1-ol as an oil.

c. 2-Bromo- 10-(1-ethoxy-ethoxy)-dec-1-ene

To a solution of 9-bromo-dec-9-en-1-ol (11.75 g, 50.0 mmol) in about 15 ml diethyl ether was added about 37 mg of p-toluenesulfonic acid monohydrate. After this solution was cooled to about −10° C., ethylvinyl ether (13.8 ml, 144 mol) was added slowly enough to keep the internal temperature below 10° C. After adding a few drops of triethylamine, the solution was washed with water and then brine. The isolated organic layer was dried over potassium carbonate then concentrated in vacuo to yield 16.2 g of about 72% pure 2-bromo-10-(1-ethoxy-ethoxy)-dec-1-ene as an oil.

d. 1,1,2-Tribromo-2-[8-(1-ethoxy-ethoxy)-octyl]-cyclopropane

To a solution of 2-bromo-10-(1-ethoxy-ethoxy)-dec-1-ene (16.2 g, 52.7 mmol) in 90.9 ml methylene chloride were added bromoform (13.2 ml, 158 mmol), N,N′-dibenzyl-N,N,N′,N′-tetramethylethylenediammonium dibromide (2.41 g, 5.27 mmol) and 45% aqueous potassium hydroxide (22.6 ml, 263 mmol.) After stirring at room temperature for 2 days, water was added, the layers were separated. To the isolated organic layer was added N,N′-dibenzyl-N, N, N′,N′-tetramethylethylenediammonium dibromide (2.41 g, 5.27 mmol) and 45% aqueous potassium hydroxide ( 22.6 ml, 263 mmol.) After stirring at room temperature for an additional 2 days, water and hexanes were added. The mixture was gravity filtered through qualitative filter paper and the layers were separated. The isolated organic layer was dried over magnesium sulfate then dried in vacuo to give 24.7 g of 1,1,2-tribromo-2-[8-(1-ethoxy-ethoxy)-octyl]-cyclopropane as an oil which was used without further purification.

e. 1-(8-Hydroxyethyl)- 1,2,2-tribromo-cyclopropane

To a solution of 1,1,2-tribromo-2-[8-(1-ethoxy-ethoxy)-octyl]-cyclopropane (24.7 g, 51.5 mmol) in about 160 ml methanol were added about 44 ml water, about 337 mg p-toluenesulfonic acid monohydrate and about 160 ml 6 M hydrochloric acid. After stirring at room temperature for about 1 hour, the reaction mixture was concentrated in vacuo. This residue was purified by vacuum distillation to give 15.6 g of 65% pure 1-(8-hydroxyethyl)-1,2,2-tribromo-cyclopropane as an oil which was used as is.

f. 1-(8-Benzenesulfonyloxyoctyl)-1,2,2-tribromo-cyclopropane To a solution of 1-(8-hydroxyethyl)-1,2,2-tribromo-cyclopropane (15.6 g, 38.3 mmol) in about 50 ml methylene chloride was added pyridine (3.72 ml, 45.9 mmol.) The solution was cooled to about −20° C. in an acetone/dry ice bath while adding benzenesulfonyl chloride (4.89 ml, 38.3 mmol.) After stirring 16 hours at room temperature, pyridine (3.72 ml, 45.9 mmol) and benzenesulfonyl chloride (4.89 ml, 38.3 mmol) were added. After stirring 5 hours at room temperature, pyridine (3.72 ml, 45.9 mmol) and benzenesulfonyl chloride (4.89 ml, 38.3 mmol) were added. After stirring 16 hours at room temperature, water was added then the phases were separated. The isolated organic layer was dried over magnesium sulfate and concentrated in vacuo. The residue was dissolved in diethyl ether then washed with saturated aqueous sodium bicarbonate. The phases were separated and the isolated organic layer was dried over magnesium sulfate and concentrated in vacuo to give 14.5 g of 1-(8-benzenesulfonyloxyoctyl)-1,2,2-tribromo-cyclopropane as an oil.

g. 1-(Benzenesulfonyloxyoctyl)-cyclopropene

A solution of 1-(benzenesulfonyloxyoctyl)-1,2,2-tribromo-cyclopropane (2.7 g, 4.94 mol) in about 8 ml diethyl ether was cooled to 0° C. and placed under a nitrogen atmosphere. To this solution was added 1.4 M methyllithium in diethyl ether (10.6 ml, 14.8 mmol.) After 15 minutes, the reaction was quenched by the addition of about 4 ml water. The phases were separated and the isolated organic layer was dried over magnesium sulfate and concentrated in vacuo to give 1.2 g of 1-(benzenesulfonyloxyoctyl)-cyclopropene as an oil.

### Example 28

### 1-(4-Methylphenylthiooctyl)-cyclopropene (Comoound 57)

a. 1-(Benzenesulfonyloxyoctyl)-cyclopropene

1-(Benzenesulfonyloxyoctyl)-cyclopropene is prepared from 1-(benzenesulfonyloxyoctyl)-1,2,2-tribromo-cyclopropane by the method shown in Example 27.

b. 1-(4-Methylphenylthiooctyl)-cyclopropene

To a suspension of sodium hydride (60% in oil, 73.2 mg, 1.83 mmol) in N,N-dimethylformamide (2 ml) was added a solution of p-thiocresol (189 mg, 1.52 mmol) in N,N-dimethylformamide (2 ml.) When bubbling had ceased after 15 minutes of stirring at room temperature, 1-(benzenesulfonyloxyoctyl)-cyclopropene (470 mg, 1.52 mmol) was added in N,N-dimethylformamide (2 ml.) After stirring for about 2 hours, water and ethyl acetate were added then the phases were separated. The isolated organic layer was washed twice with water, dried over magnesium sulfate and concentrated in vacuo to give 200 mg 1-(4-methylphenylthiooctyl)-cyclopropene as an oil.

### Example 29

### 1-(1H-1.2.4-triazol-2-ylthiooctyl)-cyclopropene (Compound 58)

a. 1-(Benzenesulfonyloxyoctyl)-cyclopropene

1-(Benzenesulfonyloxyoctyl)-cyclopropene is prepared from 1-(benzenesulfonyloxyoctyl)-1,2,2-tribromo-cyclopropane by the method shown in Example 27.

b. 1-(1H- 1,2,4-triazol-2-ylthiooctyl)-cyclopropene

To a solution of 1-(benzenesulfonyloxyoctyl)-cyclopropene (480 mg, 1.55 mmol) in about 2 ml N,N-dimethylformamide was added potassium t-butoxide (19.8% in tetrahydrofuran, 734 mg, 1.55 mmol) and 1H-1,2,4-triazole-3-thiol (172 mg, 1.71 mmol.) After stirring at room temperature for about 2 hours, sodium iodide (87.7 mg, 0.775 mmol) was added. After the reaction was heated to about 50° C. for about 2 hours, water and ethyl acetate were added then the phases were separated. The isolated organic layer was washed twice with water, dried over magnesium sulfate and concentrated in vacuo. This residue was purified by column chromatography on silica gel using hexanes/ethyl acetate to give 30 mg of 70% pure 1-(1H-1,2,4-triazol-2-ylthiooctyl)-cyclopropene as an oil.

### Example 30

### 1-(1-Methyl-2-pyrrolecarbonyloxypropyl)-cyclopropene (Compound 59)

a. 1-(3-Hydroxypropyl)-1,2,2-tribromocyclopropane

1-(3-Hydroxypropyl)-1,2,2-tribromocyclopropane was prepared from 3-(1,2,2-tribromo-cyclopropyl)-propionic acid by the method described in Example 26d.

b. 1-(3-Hydroxypropyl)-cyclopropene

A solution of 1-(3-hydroxypropyl)-1,2,2-tribromocyclopropane (750 mg, 2.22 mmol) in about 4 ml diethyl ether was cooled to 0° C. and placed under a nitrogen atmosphere. 1.4 M methyllithium (6.36 ml, 8.90 mmol) was added via syringe. After 15 minutes, about 2 ml water was added then the phases were separated. The isolated organic layer was dried over magnesium sulfate and then concentrated in vacuo to yield 1-(3-hydroxypropyl)-cyclopropene which was used as is.

c. 1-(1-Methyl-2-pyrrolecarbonyloxypropyl)-cyclopropene

To a solution of 1-(3-hydroxypropyl)-cyclopropene (221 mg, 2.22 mmol) in about 15 ml methylene chloride, was added 1-methyl-2-pyrrolecarboxylic acid (306 mg, 2.42 mmol), 4-dimethylaminopyridine (27.0 mg, 0.222 mmol) and p-toluenesulfonic acid monohydrate (21.2 mg, 0.111 mmol.) After the mixture was cooled to about 15° C., a solution of N,N′-dicyclohexylcarbodiimide (550 mg, 2.66 mmol) in about 10 ml methylene chloride was added slowly portionwise. After stirring at room temperature for about 2 hours, the reaction mixture was vacuum filtered through extremely retentive filter paper. Water was added then the phases were separated. The isolated organic layer was dried over magnesium sulfate and then concentrated in vacuo. This residue was purified by column chromatography on silica gel using hex anes/ethyl acetate to give 15 mg of 1-(1-methyl-2-pyrrolecarbonyloxypropyl)-cyclopropene as an oil.

### Example 31

### 1-Ethyl-2-(3-(4-chlorolhenyl)-pyridaz-6-on-1-yl)-cyclolroi)ene (Compound 60)

a. 3-(4-Chlorophenyl)-pyridaz-6-one

3-(4-Chlorophenyl)-pyridaz-6-one can be prepared as described in Example 3 of DE Pat. No. 2435244 (1976.)

b. 1-(Methanesulfonyloxymethyl)-2-ethylcyclopropene

1-(Methanesulfonyloxymethyl)-2-ethylcyclopropene is prepared from by the method shown in Example 17c.

c. 1-Ethyl-2-(3-(4-chlorophenyl)-pyridaz-6-on-1-yl)-cyclopropene

To a suspension of sodium hydride (60% in oil, 0.08 g, 2 mmol) in N,N-dimethylformamide (4 ml) in an ice bath is added 3-(4-chlorophenyl)-pyridaz-6-one (0.41 g, 2 mmol.) After stirring for 15 minutes, 1-(methanesulfonyloxymethyl)-2-ethylcyclopropene (0.35 g, 2 mmol) is added. After stirring for 45 minutes at room temperature, water and ethyl acetate were added. The phases were separated. The isolated organic layer was washed sequentially with water and brine then dried over magnesium sulfate and finally dried in vacuo. This residue was purified by column chromatography in silica gel using hexanes/ethyl acetate to give 340 mg of 1-ethyl-2-(3-(4-chlorophenyl)-pyridaz-6-on-1-yl)-cyclopropene as an off-white solid.

### Example 32

### Preparation of 1-Triethylsilylmethylcyclopropene (Compound 63)

a. 3-Trichlorosilyl-2-bromopropene

This compound was prepared as described in Hollingworth, G. J.; Lee, T. V. Sweeney, J. B. Synthetic Commun. 1996, 26, 1117. The product was mixed with hexane and filtered. The filtrate was stripped and used without further purification (no distillation was carried out).

b. 3-Triethylsilyl-2-bromopropene

To a solution of 1.3 g of 3-trichlorosilyl-2-bromopropene (5 mmol) in 20 ml of THF in an ice bath is added 7 ml (3.0M, 21 mmol) of ethylmagnesium bromide. The reaction was warmed to room temperature and stirred overnight, then quenched with water. Ether was added and the reaction mixture was transferred into a separatory funnel. A small amount of 1 N HCl was added, the phases were separated, the ether phase was washed with water and brine, then dried over magnesium sulfate, filtered, and stripped. Chromatography gave 300 mg of 3-triethylsilyl-2-bromopropene.

c. N,N′-dibenzyl-N,N,N′,N′-tetramethylethylenediammonium dibromide and N,N′-dibenzyl-N,N,N′,N′-tetraethylethylenediammonium dibromide (Phase transfer catalysts).

To a stirred solution of 16.5 g (142 mmol) of N,N,N′,N′-tetramethylethylenediamine in 60 g of acetonitrile was added 50.1 g (292 mmol) of benzyl bromide. The mixture self warmed and was allowed to stir for 2.5 hours whereon a heavy precipitate was observed. The slurry was diluted with diethyl ether, filtered, washed with diethyl ether and dried yielding 61.8 g of the desired N,N′-dibenzyl-N,N,N′,N′-tetramethylethylenediammonium dibromide, a white solid mp 230-232° C.

In an analogous way, using N,N,N′,N′-tetraethylethylenediamine one obtains N,N,-dibenzyl-N,N,N′,N′-tetraethylethylenediammonium dibromide, a white solid mp 190-193° C., decomposes.

d) 2-Triethylsilylmethyl-1,1,2-tribromocyclopropane

A mixture of 300 mg (1.27 mmol) of 3-triethylsilyl-2-bromopropene, 0.47 g of 45% aqueous potassium hydroxide solution (3.8 mmol), 75 mg N,N′-dibenzyl-N,N,N′,N′-tetraethylethylenediammonium dibromide, and 3 ml of methylene chloride was treated with 0.33 ml of bromoform (3.8 mmol). The well-stirred reaction mixture was held for 5.5 hours at room temperature. Water and methylene chloride were added, the phases were separated. The methylene chloride phase was placed in a reaction flask and treated with an additional 0.47 g of 45% aqueous potassium hydroxide solution (3.8 nmmol) and 75 mg N,N′-dibenzyl-N,N,N,N′-tetraethylethylenediammonium dibromide. The reaction mixture was stirred overnight, then water and additional methylene chloride were added and the phases were separated. The methylene chloride phase was dried over magnesium sulfate, and stripped. A small amount of heptane was added during the strip to help remove remaining bromoform. Column chromatography gave 390 mg of 2-triethylsilylmethyl-1,1,2-tribromocyclopropane as a colorless liquid.

e) 1-Triethylsilylmethylcyclopropene

A solution of 0.36 g (0.9 mmol) of 2-triethylsilylmethyl-1,1,2-tribromocyclopropane in 5 ml of ether was cooled to −78° C. Excess methyllithium (1.4M, 2.0 ml, 2.8 mmol) was added, and the reaction mixture was placed in an ice bath for 5 min, then sampled. The reaction mixture was cooled back to −78° C. during the sampling. The reaction was quenched with a small amount of methanol, and warmed to room temperature. Additional ether and water were added. The phases were separated. The ether phase was washed with water, washed with brine, dried over magnesium sulfate and stripped to give 100 mg of 1-triethylsilylmethylcyclopropene as a colorless liquid.

### Example 33

### Preparation of 1-Trimethylsilylmethylcyclopropene (Compound 64)

Commercially available 3-trimethylsilyl-2-bromopropene was converted to 1-trimethylsilylmethylcyclopropene in a similar manner as described for Example 1.

### Example 34

### Preparation of 6-(Trimethylsilyl)-hexylcycloprop-2-ene (Compound 65)

a. 2-Bromo-8-(trimethylsilyl)-oct-1-ene

Commercially available pentamethylenebis(magnesium bromide) (50 ml, 0.5 M in THF, 25 mmol) was cooled in an ice bath. A solution of 2.72 g (25 mmol) of trimethylchlorosilane in 10 ml of THF was added. The reaction mixture twas stirred at 50° C. for 30 minutes then at room temperature for 1 hour, then recooled to 5° C. 2,3-Dibromopropene (5.0 g, 25 mmol) in 6 ml of THF was added to the reaction mixture, which was warmed to room temperature and stirred for two hours. The reaction mixture was quenched with water. Ether and a small amount of 1N HCl was added. The phases were separated, and the organic phase was washed with water and brine, dried over magnesium chloride and stripped. Column chromatography gave 1.62 g of 2-bromo-8-(trimethylsilyl)-oct-1-ene as a colorless oil.

b. 2-(6-(Trimethylsilyl)-hexyl)-1,1,2-tribromocyclopropane

A mixture of 1.52 g (5.8 mmol) of 2-bromo-8-(trimethylsilyl)-oct-1-ene, 4.3 g of 45% aqueous potassium hydroxide solution (34 mmol), 0.2 g N,N′-dibenzyl-N,N,N′,N′-tetraethylethylenediammonium dibromide, and 10 ml of methylene chloride was treated with 1.5 ml of bromoform (17.4 mmol). The well-stirred reaction mixture was held overnight at room temperature. An additional 4 g of 45% aqueous potassium hydroxide solution was added and the reaction was stirred an additional hour at room temperature. Water and methylene chloride were added, the phases were separated. The methylene chloride phase was dried over magnesium sulfate, and stripped. A small amount of heptane was added during the strip to help remove remaining bromoform. Column chromatography gave 1.13 g of 2-(6-(trimethylsilyl)-hexyl)-1,1,2-tribromocyclopropane as a colorless oil.

c. 6-(Trimethylsilyl)-hexylcycloprop-2-ene

A solution of 0.96 g (2.2 mmol) of 2-(6-(trimethylsilyl)-hexyl)-l,1,2-tribromocyclopropane in 10 ml of ether was cooled to −78° C. Excess methyllithium (1.4M, 5.1 ml, 7.1 mmol) was added, and the reaction mixture was placed in an ice bath for 30 min, then quenched with water. The phases were separated. The ether phase was washed with water, washed with brine, dried over magnesium sulfate and stripped to give 370 mg of 6-(trimethylsilyl)-hexylcycloprop-2-ene as a colorless liquid.

### Example 35

### Preparation of 2-(Trimethylsilyl)-ethylcycloprop-2-ene (Compound 66)

a. 2-Bromo4-(trimethylsilyl)-but-1-ene

To solution of 5.0 g (50 mmol) of 2,3-dibromopropene in 20 ml of ether cooled in an ice bath was added 30 ml of commercially available trimethylsilylmethylmagnesium chloride (1M, 30 mmol). The reaction mixture was stirred at 0° C. for 30 minutes, then warmed to room temperature. THF (10 ml) was added, and the reaction mixture was stirred overnight. It was quenched with water. The reaction mixture was transferred into a separatory funnel. A small amount of 1 N HCl was added, the phases were separated, the ether phase was washed with water and brine, then dried over magnesium sulfate, filtered, and stripped to give 4.5 g of 2-bromo4-(trimethylsilyl)-but-1-ene which was used without further purification.

b. 2-(Trimethylsilyl)-ethylcycloprop-2-ene

2-Bromo4-(trimethylsilyl)-but-1-ene was converted to 2-(trimethylsilyl)-ethylcycloprop-2-ene in an analogous fashion to the conversion of 2-bromo-8-(trimethylsilyl)-oct-1-ene to 6-(trimethylsilyl)-hexylcycloprop-2-ene (Example 3).

### Example 36

### Preparation of 2-Octyl-1-trimethylsilylcyclopropene (Compound 67)

a. 2-Bromodec-1-ene

Into a 500 ml 3 necked flask equipped with magnetic stirring, an addition funnel, and a reflux condenser was added 17 g (700 mmol) of magnesium turnings. The atmosphere was exchanged for dry nitrogen and the turnings were covered with 20 ml of diethyl ether. 2 g of 1,2-dibromoethane was added whereon a reaction occurred as evidenced by some bubbling and cloudiness. After 5 minutes, 200 ml of diethyl ether was added and the mixture brought to reflux. Slow addition of 90 g (503 mmol) of 1-bromoheptane in 100 ml of diethyl ether at a rate sufficient to maintain reflux took 50 minutes. The reaction was further refluxed for 30 minutes yielding a solution of heptyl magnesium bromide.

Into a 1000 ml 3 necked flask equipped with magnetic stirring, a septum, and a reflux condenser under a nitrogen atmosphere was added 75 g (375 mmol) of 2,3-dibromopropene in 200 ml of diethyl ether. The so!ution of heptyl magnesium bromide was transferred, via cannula, to this reaction at a rate to control the reflux. After refluxing for an additional 60 minutes the reaction was let stir overnight at room temperature. The reaction was quenched with aqueous hydrochloric acid, washed with brine, dried over anhydrous magnesium sulfate, rotovapped, and distilled at 12 torr through a 5 tray perforated plate column yielding 52 g of 2-bromodec-1-ene bp (12 torr) 105-115° C.

b. 2-Octyl- 1,1,2-tribromocyclopropane

Into a 125 ml single necked flask with magnetic stirring was added 20 g (91 mmol) of 2-bromodec-1-ene, 75 g (297 mmol) of bromoform, 200 g of methylene chloride, 2.2 g of N,N′-dibenzyl-N,N,N′,N′-tetramethylethylenediammonium dibromide, and 20 g (161 mmol) of 45% aqueous potassium hydroxide. The mixture was stirred for 3 days, whereon 100 ml of water was added and the organic layer was separated and retreated with 30 g of bromoform, 2.0 g of N,N′-dibenzyl-N,N,N,,N′-tetramethylethylenediammonium dibromide, and 25 g of 45% aqueous potassium hydroxide. After stirring for an additional two-days the reaction was washed with water, dried, rotovapped and chromatographed on silica gel eluting with hexanes. One obtains 41 g of 2-octyl- 1,1,2-tribromocyclopropane.

c. 2-Octyl- 1-trimethylsilylcyclopropene

A solution of 0.98 g (2.5 mmol) of 2-octyl-1,1,2-tribromocyclopropane in 10 ml of ether was cooled to −78° C. Methyllithium (1.4M, 5.35 ml, 7.5 mmol) was added, and the reaction mixture was stirred for 30 min, then placed in an ice bath and held for 30 minutes. Trimethylsilylchloride (0.81g, 7.5 mmol) was added, and the reaction mixture was held for 45 minutes then quenched with water. Additional ether was added and the phases were separated. The ether phase was washed with water, washed with brine, dried over magnesium sulfate and stripped to give 370 mg of 2-octyl-1-trimethylsilylcyclopropene as a yellow liquid.

### Example 37

### Preparation of 1-(2-Methanesulfonyloxyethyl)-cyclopropene (Compound 68)

a. 2-Bromo4-(1-ethoxy-ethoxy)-but-1-ene

While cooling a solution of 10.38 g (0.0687 mol) of commercially available 3-bromo-3-buten-1-ol in 20 ml of diethyl ether with 50 mg (0.000263 mol) p-toluene sulfonic acid monohydrate in an ice water bath, 19 ml (0.199 mol) of ethyl vinyl ether was added slowly dropwise to maintain an internal temperature of <10° C. After 1 hour at 0° C., a few drops of triethylamine was added. The reaction mixture was poured onto water. The resulting mixture was transferred to a separatory funnel and the phases were separated. The isolated organic layer was washed with brine then dried over potassium carbonate and filtered. The solvent was removed from the filtrate in vacuo to yield 14.04 g of 2-bromo-4-(1-ethoxy-ethoxy)-but-1-ene as an oil.

b. 1,1,2-Tribromo-2-[2-(1-ethoxy-ethoxy)-ethyl]-cyclopropane

To a solution of 14.02 g (0.0628 mol) 2-bromo-4-(1-ethoxy-ethoxy)-but-1-ene in 108 ml methylene chloride with 0.5-0.9 ml 45% aqueous potassium hydroxide was added 16.4 ml (0.118 mol) of bromoform and 2.88 g (0.00628 mol) of N,N′-dibenzyl-N,N,N′,N′-tetramethylethylenediammonium dibromide and 28 ml (0.314 mol) 45% aqueous potassium hydroxide. After 3 days the reaction mixture was poured onto water. The resulting mixture was transferred to a separatory funnel and the phases were separated. To the isolated organic layer was added 2.88 g (0.00628 mol) of N,N′-dibenzyl-N,N,N′,N′-tetramethylethylenediammonium dibromide and 28 ml (0.314 mol) 45% aqueous potassium hydroxide. After 24 hours, there was added hexanes and water. This mixture was gravity filtered through qualitative fluted filter paper. The resulting mixture was transferred to a separatory funnel and the phases were separated. The organic layer was dried over MgSO₄ and filtered. The solvent was removed from the filtrate in vacuo to yield 17.0 g of 1,1,2-tribromo-2-[2-(1-ethoxy-ethoxy)-ethyl]-cyclopropane as an oil.

c. 2-(2-Hydroxyethyl)-1,1,2-tribromocyclopropane

To a slurry of 16.5 g (0.0418 mol) of 1,1,2-tribromo-2-[2-(1-ethoxy-ethoxy)-ethyl]-cyclopropane in 145 ml methanol and 40 ml water, was added 0.306 g (0.00161 mol) p-toluene sulfonic acid monohydrate and 145 ml 6M hydrochloric acid. After stirring at room temperature for 1 hour, the solvent was removed from the reaction mixture in vacuo. To the residue, there was added ethyl acetate and water. The resulting mixture was transferred to a separatory funnel and the phases were separated. The isolated organic layer was washed with brine then dried over MgSO₄ and filtered. The solvent was removed from the filtrate in vacuo to yield 11.9 g of 2-(2-hydroxyethyl)-1,1,2-tribromocyclopropane as an oil.

d. 1-(2-Hydroxyethyl)-cyclopropene

A solution of 1.15 g (3.6 mmol) of 2-(2-hydroxyethyl)-1,1,2-tribromocyclopropane, (preparation described above) in 40 ml of ether was cooled to −78° C. Methyllithium (1.4M, 10.3 ml, 14.4 mmol) was added. The reaction mixture was warmed to 5° C. and held for one half hour. The reaction was quenched with water and the phases were separated. The ether phase was washed with water, washed with brine, dried over magnesium sulfate and stripped. The crude product was immediately used in the next reaction.

e) 1-(2-Methanesulfonyloxyethyl)-cyclopropene

The crude product of the above reaction was dissolved in 5 ml of ether and cooled in an ice bath. Triethylamine (1 ml) was added, then 0.49 g of methanesulfonyl chloride (4.3 mmol) was added. The reaction mixture was stirred for 1 hour. Water and additional ether were added and the phases were separated. The ether phase was washed with water twice, washed with brine, dried over magnesium sulfate and stripped to give 380 mg of 1-(2-methanesulfonyloxyethyl)-cyclopropene as a pale yellow liquid.

### Example 38

### Preparation of 1-(7-Methanesulfonyloxyheptyl)-cyclopropene (Compound 69)

a. 1-(1-Ethoxyethoxy)-6-bromohexane

To a cooled solution of 80 mg of toluenesulfonic acid in 40 ml of ether was fed 20 g (110 mmol) of 6-bromohexanol and 40 ml of ethyl vinyl ether simultaneously by separate additional funnels. The temperature of the reaction mixture was kept at 7° C. or lower during the feeds, which took 1 hour. The reaction mixture was stirred 20 minutes longer, then roughly 1 ml of triethylamine was added. The reaction mixture was washed with water and brine, dried over potassium carbonate, filtered and stripped to give 25.7 g of a pale yellow liquid, which was used without further purification.

b. 9-(1-Ethoxyethoxy)-2-bromonon-1-ene

A slurry of 5.6 g of magnesium turnings (230 mmol) in 100 ml of THF was treated with a small amount of 1,2-dibromoethane. 1-(1-Ethoxyethoxy)-6-bromohexane (38.5 g, 152 mmol) was fed slowly to the reaction mixture, maintaining the temperature at 40-50° C. At the end of the addition the reaction mixture was held 20 minutes, then transferred by cannula to solution of 33.4 g (167 mmol) of 2,3-dibromopropene in 25 ml of THF at 0° C. The reaction mixture was stirred at 0° C. for 15 minutes, then stirred at room temperature for 15 minutes, then quenched with water. The reaction mixture was transferred into a separatory funnel. A small amount of 1 N HCl was added, the phases were separated, the ether phase was washed with water and brine, then dried over magnesium sulfate, filtered, and stripped to give 33.63 g of a yellow liquid which was used without further purification.

c. 1,1,2-Tribromo-2-(7-hydroxyheptyl)cyclopropane

A mixture of 9-(1-ethoxyethoxy)-2-bromonon-1-ene (33.63g, 115 mmol), 4.1 g of N,N′-dibenzyl-N,N,N′,N′-tetraethylethylenediammonium dibromide, 42 g of 45% potassium hydroxide (337 mmol), 93 g of bromoform (368 mmol) and 280 g of methylene chloride were rapidly stirred at room temperature for two days. When the reaction stalled, the reaction mixture was transferred to a separatory funnel and washed with water. The methylene chloride phase was transferred to a flask and treated with the same amount of the phase transfer catalyst and 45% potassium hydroxide as before, then stirred at room temperature for an additional 3 days. The reaction mixture was washed with water, the methylene chloride phase was dried with magnesium sulfate, and then stripped. The product was treated with 320 ml of methanol and 40 ml of 1N HCl for 1 hour at room temperature. The methanol was stripped, ethyl acetate was added. The organic phase was washed with water and brine, then treated with 200 ml of silica gel. Filtration followed by a strip gave 38 g of black product. This was chromatographed on silica gel to give 19.0 g of 1,1,2-tribromo-2-(7-hydroxyheptyl)cyclopropane as a pale yellow liquid.

d. 1-(7-Hydroxyheptyl)-cyclopropene

A solution of 1.0 g 1,1,2-tribromo-2-(7-hydroxyheptyl)cyclopropane (2.5 mmol) in 25 ml of ether was treated at −78° C. with 7.2 ml of methyllithium (1.4 M, 10 mmol). After 5 minutes, the reaction mixture was warmed to 0° C. and held at this temperature. The reaction was quenched with saturated ammonium chloride. The reaction mixture was washed with water and brine, dried over magnesium sulfate, filtered and stripped to give 240 mg of 1-(7-hydroxyheptyl)-cyclopropene.

e. 1-(7-Methanesulfonyloxyheptyl)-cyclopropene

A solution of 4.3 mmol of 1-(7-hydroxyheptyl)-cyclopropene in 50 ml of ether was cooled in an ice bath. Triethylamine (1 ml) and 0.54 g of methanesulfonyl chloride (4.7 mmol) were added and the reaction mixture was stirred for 2½ hours at 0° C. The reaction mixture was washed with water and brine, dried over magnesium sulfate, filtered and stripped to give 0.83 g of 1-(7-methanesulfonyloxyheptyl)-cyclopropene.

### Example 39

### Preparation of 1-(7-Ethanethioheptyl)-cyclopropene (Compound 70)

A mixture of 0.35 g (1.5 mmol) of 1-(7-methanesulfonyloxyheptyl)-cyclopropene and 0.36 g of 80% sodium ethanethiolate (4.5 mmol) in DMF was stirred at room temperature for one hour. Ether and water were added, and the phases were separated. The organic phase was washed with 1N sodium hydroxide solution, water (2×) and brine, dried over magnesium sulfate, filtered and stripped. Chromatography gave 140 mg of 1-(7-ethanethioheptyl)-cyclopropene as a colorless liquid.

### Example 40

### Preparation of 1-Bromo-2-octyl-cyclopropene (Compound 71)

a. 2-Bromodec-1-ene

Into a 500 ml 3 necked flask equipped with magnetic stirring, an addition funnel, and a reflux condenser was added 17 g (700 mmol) of magnesium turnings. The atmosphere was exchanged for dry nitrogen and the turnings were covered with 20 ml of diethyl ether. 2 g of 1,2-dibromoethane was added whereon a reaction occurred as evidenced by some bubbling and cloudiness. After 5 minutes, 200 ml of diethyl ether was added and the mixture brought to reflux. Slow addition of 90 g (503 mmol) of 1-bromoheptane in 100 ml of diethyl ether at a rate sufficient to maintain reflux took 50 minutes. The reaction was further refluxed for 30 minutes yielding a solution of heptyl magnesium bromide.

Into a 1000 ml 3 necked flask equipped with magnetic stirring, a septum, and a reflux condenser under a nitrogen atmosphere was added 75 g (375 mmol) of 2,3-dibromopropene in 200 nil of diethyl ether. The solution of heptyl magnesium bromide was transferred, via cannula, to this reaction at a rate to control the reflux. After refluxing for an additional 60 minutes the reaction was let stir overnight at room temperature. The reaction was quenched with aqueous hydrochloric acid, washed with brine, dried over anhydrous magnesium sulfate, rotovapped, and distilled at 12 torr through a 5 tray perforated plate column yielding 52 g of 2-bromodec-1-ene bp (12 torr) 105-115° C.

b. N,N′-dibenzyl-N,N,N′,N′-tetramethylethylenediammonium dibromide (Phase transfer catalyst)

To a stirred solution of 16.5 g (142 mmol) of N,N,N′,N′-tetramethylethylenediamine in 60 g of acetonitrile was added 50.1 g (292 mmol) of benzyl bromide. The mixture self warmed and was allowed to stir for 2.5 hours whereon a heavy precipitate was observed. The slurry was diluted with diethyl ether, filtered, washed with diethyl ether and dried yielding 61.8 g of the desired N,N′-dibenzyl-N,N,N′,N′-tetramethylethylenediammonium dibromide, a white solid mp 230-232° C.

c. 2-Octyl-1,1,2-tribromocyclopropane

Into a 125 ml single necked flask with magnetic stirring was added 20 g (91 mmol) of 2-bromodec-1-ene, 75 g (297 mmol) of bromoform, 200 g of methylene chloride, 2.2 g of N,N′-dibenzyl-N,N,N′,N′-tetramethylethylenediammonium dibromide, and 20 g (161 mmol) of 45% aqueous potassium hydroxide. The mixture was stirred for 3 days, whereon 100 ml of water was added and the organic layer was separated and retreated with 30 g of bromoform, 2.0 g of N,N′-dibenzyl-N,N,N′,N′-tetramethylethylenediammonium dibromide, and 25 g of 45% aqueous potassium hydroxide. After stirring for an additional two days the reaction was washed with water, dried, rotovapped and chromatographed on silica gel eluting with hexanes. One obtains 41 g of 2-octyl-1,1,2-tribromocyclopropane.

d. 1-Bromo-2-octyl-cyclopropene

A solution of 3.18 g (0.00813 mol) of 1,1,2-tribromo-2-octyl-cyclopropane in 6 ml of diethyl ether was placed under a nitrogen atmosphere via use of a Firestone valve. While cooling in an ice water bath, 5.81 ml (0.00813 mol) of 1.4M methyl lithium in diethyl ether was added slowly by syringe. After 15 minutes, 2 ml of water was added via syringe. The resulting mixture was transferred to a separatory funnel and the phases were separated. The organic layer was dried over MgSO₄ and filtered. The solvent was removed from the filtrate in vacuo with a bath temperature under 20° C. to yield 1.43 g of 1-bromo-2-octyl-cyclopropene as an oil.

### Example 41

### Preparation of 3-Methyl-3-pentyl-cyclopropene (Compound 72)

a. 1,1-Dibromo-2-methyl-2-pentyl-cyclopropane

To a solution of 7.01 ml (0.0446 mol) of 2-methyl-hept-1-ene in 14.4 ml (0.162 mol) of bromoform was added 0.635 g (0.00193 mol) of tetrabutylammonium bromide and 15.1 ml (0.185 mol) of 50% aqueous sodium hydroxide. After heating to 55° C. for 1 hour, the reaction was cooled to room temperature and hexanes and water were added. The resulting mixture was transferred to a separatory funnel and the phases were separated. The organic layer was dried over MgSO₄ and filtered. The solvent was removed from the filtrate in vacuo. The residue was purified by vacuum distillation to yield 10.9 g of 1,1-dibromo-2-methyl-2-pentyl-cyclopropane.

b. 2-Bromo-1-methyl-1-pentyl-cyclopropane

To a solution of 6.59 g (0.0232 mol) of 1,1-dibromo-2-methyl-2-pentyl-cyclopropane in about 20 ml of methanol was added 1.47 ml (0.0255 mol) of glacial acetic acid and 1.49 g (0.0227 mol) of zinc dust. After stirring 1 hour, 1.47 ml (0.0255 mol) of glacial acetic acid and 1.49 g (0.0227 mol) of zinc dust were added to the reaction mixture. After stirring for 2 hours, the reaction mixture was concentrated in vacuo. After adding hexanes and water, the resulting mixture was transferred to a separatory funnel and the phases were separated. The organic layer was dried over MgSO₄ and filtered. The solvent was removed from the filtrate in vacuo to yield 2.2 g of 2-bromo- 1-methyl-1-pentyl-cyclopropane 95% pure as an oil.

c. 3-Methyl-3-pentyl-cyclopropene

To a solution of 1.03 g (0.502 mol) of 2-bromo-1-methyl-1-pentyl-cyclopropane in 5 ml of dimethylsulfoxide was added 0.563 g (0.502 mol) of potassium tert-butoxide. After heating to 85° C. for 2 hours, an additional 0.075 g (0.00516 mol) of potassium tert-butoxide was added. After heating to 85° C. for 1 hour, water and diethyl ether were added. The resulting mixture was transferred to a separatory funnel and the phases were separated. The organic layer was dried over MgSO₄ and filtered. The solvent was removed from the filtrate in vacuo. The residue was taken up in 4 ml of dimethylsulfoxide to which 0.6 g (0.536 mol) of potassium tert-butoxide was added. After heating for 7 hours at 90° C., added water and ethyl acetate then resulting mixture was transferred to a separatory funnel where the phases were separated. The organic layer was dried over MgSO₄ and filtered. The solvent was removed from the filtrate in vacuo to yield 180 mg of 3-methyl-3-pentyl-cyclopropene as a 50% mixture with t-butanol.

### Example 42

### Preparation of 3-Methyl-3-nonyl-cyclopropene (Compound 73)

This compound was prepared in a similar manner to compound 2. It was obtained as a mixture of 40% 3-methyl-3-nonyl-cyclopropene, 30% l-methyl-1-nonyl-cyclopropane and 20% 1-methyl-1-nonyl-2-bromocyclopropane.

### Example 43

### Preparation of 1-Heptyl-2-methyl-cyclopropene (Compound 74)

A solution of 1 mg of 1,10-phenanthroline, 1.74 ml of tetramethylethylenediamine, and 20 ml of tetrahydrofuran was placed under a nitrogen atmosphere via use of a Firestone valve. While cooling to -30° C., 1.5 ml of 1-methylcyclopropene (prepared from 3-chloro-2-methyl-propene; see Hopf, H.; Wachholz, G.; Walsh, R. Chem. Ber. 1985, 118, 3579, and Köster, R et al., Liebigs Annalen Chem. 1973, 1219-1235) was added via plastic syringe. While cooling in a −40° C. bath, 8 ml (11.5 mmol) of 1.6 M n-butyl lithium in hexanes was added slowly via syringe. After 15 minutes at −30° C., 1.90 ml (11.5 mmol) of 1-iodoheptane was added dropwise via syringe. After stirring 30 minutes while warming naturally to attain a temperature of 5° C., the reaction mixture was dried in vacuo with a bath temperature under 20° C. After adding diethyl ether and 1N hydrochloric acid the resulting mixture was transferred to a separatory funnel and the phases were separated. The organic layer was dried over MgSO₄ and filtered. The solvent was removed from the filtrate in vacuo with a bath temperature under 20° C. This residue was purified by column chromatography with hexanes to give 0.700 g of 1-heptyl-2-methyl-cyclopropene as an oil.

### Example 44

### Preparation of 1-Bromo-2-(2-(carbo(acetoxylmethyl))ethyl-cyclopropene (Compound 75)

a. 2-(2-Bromo-allyl)-malonic Acid Diethyl Ester

The oil was removed from 21.70 g (0.542 mol) of 60% sodium hydride in oil by washing with hexanes. To the residue suspended in 200 ml tetrahydrofuran, 84.38 ml (0.556 mol) diethyl malonate was added slowly via addition funnel. While the reaction was cooled to −35 to −10° C., 100 g (0.400 mol) of 2,3-dibromopropene was added slowly via addition funnel. After heating to reflux for 1 hour, the reaction was cooled to room temperature and concentrated in vacuo. Hexanes and water were added to the residue and the resulting mixture was transferred to a separatory funnel where the phases were separated. The isolated organic layer was washed with lNhydrochloric acid then dried over magnesium sulfate and filtered. The solvent was removed from the filtrate in vacuo to yield 154 g of 2-(2-bromo-allyl)-malonic acid diethyl ester as an oil.

b. 2-(2-Bromo-allyl)-malonic Acid

A mixture of 10.5 g (0.0376 mol) of 2-(2-bromo-allyl)-malonic acid diethyl ester and 37.6 ml (0.470 mol) of 50% aqueous sodium hydroxide was stirred at room temperature for 4 days. The reaction mixture was extracted with diethyl ether. The isolated aqueous layer was acidified by the addition of concentrated hydrochloric acid and diethyl ether was added. The resulting mixture was transferred to a separatory funnel where the phases were separated. The isolated organic layer dried over magnesium sulfate and filtered. The solvent was removed from the filtrate in vacuo to yield 5.3 g of 2-(2-bromo-allyl)-malonic acid as a solid which was carried on without purification.

c. 4-Bromo-pent-4-enoic Acid

5.3 g (0.0238 mol) of neat, unpurified 2-(2-bromo-allyl)-malonic acid was heated to 125-130° C. for 8 hours to yield 3.73 g of 4-bromo-pent4-enoic acid which was carried on without purification.

d. 4-Bromo-pent4-enoic Acid Ethyl Ester

To a solution of 3.73 g (0.0208 mol) of unpurified 4-bromo-pent-4-enoic acid in 3 ml chloroform with 1 drop of N,N-dimethylformamide was added 1.18 ml (0.0162 mol) of thionyl chloride. After this mixture had been heated to 60° C. for 30 minutes, it was added to a solution of 2.46 ml (0.0436 mol) ethanol and 1.97 ml (0.024 mol) pyridine and 13. ml methylene chloride. After stirring for 30 minutes, the reaction mixture was concentrated in vacuo. To the residue was added diethyl ether and water. The resulting mixture was transferred to a separatory funnel where the phases were separated. The isolated organic layer was dried over magnesium sulfate and filtered. The solvent was removed from the filtrate in vacuo to yield 3.5 g of 4-bromo-pent-4-enoic acid ethyl ester as an oil which was purified via vacuum distillation.

e. 1,1,2-Tribromo-2-(2-(carboethoxy))ethyl-cyclopropene

1,1,2-Tribromo -2-(2-(carboethoxy))ethyl-cyclopropene was prepared in a manner similar to that of.2-octyl- 1,1,2-tribromocyclopropane (Example 1).

f. 1,1,2-Tribromo -2-(2-(carboxy))ethyl-cyclopropene

After a solution of 10.2 g (0.0269 mol) of 1,1,2-tribromo -2-(2-(carboethoxy))ethyl-cyclopropene in 40 ml (0.736 mol) of 48% hydrobromic acid and 40 ml of water was heated to reflux for 8 hours, it was cooled to room temperature and then vacuum filtered through Shark Skin® filter paper. The isolated solid was washed with water before adding diethyl ether. The solution was transferred to a separatory funnel where it was washed with saturated aqueous sodium bicarbonate which was isolated and made acidic by the addition of 1N hydrochloric acid. The aqueous solution was returned to a separatory funnel and extracted with diethyl ether. The isolated organic layer was dried over magnesium sulfate and filtered. The solvent was removed from the filtrate in vacuo to yield 5.9 g of 1,1,2-tribromo -2-(2-(carboxy))ethyl-cyclopropene as a solid which was used without further purification.

g. 1,1,2-Tribromo-2-(2-(carbo(acetoxylmethyl))ethyl-cyclopropene

To a solution of 0.800 g (0.00228 mol) of 3-1,1,2-tribromo -2-(2-(carboxy))ethyl-cyclopropene in about 2 ml anhydrous N,N-dimethylformamide was added 0.224 ml (0.00228 mol) of bromomethyl acetate then 0.396 ml (0.00228 mol) of diisopropylethylamine. After heating to 60° C. for 2 hours, water and diethyl ether were added. The resulting mixture was transferred to a separatory funnel where the phases were separated. The aqueous layer was extracted with ethyl acetate. The combined organic phases were washed sequentially with water and brine. The organic layer was dried over MgSO₄ and filtered. The solvent was removed from the filtrate in vacuo to yield 0.900 g of 1,1,2-tribromo-2-(2-(carbo(acetoxylmethyl))-ethyl-cyclopropene

h. 1-Bromo-2-(2-(carbo(acetoxylmethyl))-ethyl-cyclopropene

To a solution of 0.800 g (0.00202 mol) of 1,1,2-tribromo-2-(2-(carbo(acetoxylmethyl))-ethyl-cyclopropene in 1.04 ml (0.00808 mol) of diethyl phosphite was added 0.281 ml (0.00202 mol) of triethylamine. After stirring for about 16 hours, the reaction mixture was taken up in hexanes which was washed with 1N hydrochloric acid. The aqueous layer was then extracted with diethyl ether. The combined organic phases were washed with 3N aqueous sodium carbonate. The organic layer was dried over MgSO₄ and filtered. The solvent was removed from the filtrate in vacuo with a bath temperature under 20° C. This residue was resubjected to the reaction conditions outlined above and subsequently worked up in that same manner. The residue was purified via column chromatography using diethyl ether/hexanes to yield 180 mg of 1-bromo-2-(2-(carbo(acetoxylmethyl))-ethyl-cyclopropene as an oil.

### Example 45

### Preparation of 1-Bromo-2-(2-(carboethoxy)-ethyl-cyclopropene (Compound 76)

1-Bromo-2-(2-(carboethoxy)-ethyl-cyclopropene was prepared from 1,1,2-tribromo-2-(2-(carboethoxy)-ethyl-cyclopropene in a manner similar to the preparation 1-bromo-2-(2-(carbo(acetoxylmethyl))-ethyl-cyclopropene from 1,1,2-tribromo-2-(2-(carbo(acetoxylmethyl))-ethyl-cyclopropene (Example 5).

### Example 46

### Preparation of 1-Bromo-2-(2-(carboxn)-ethyl-cyclopropene (Compound 77)

To a solution of 200 mg (0.913 mmol) of 1-bromo-2-(2-(carboethoxy)-ethyl-cyclopropene in 2 ml of absolute ethanol was added 0.0768 g (1.37 mmol) of potassium hydroxide. After stirring for 1 hour, diethyl ether and water were added. The resulting mixture was transferred to a separatory funnel and the phases were separated. After the isolated aqueous layer was acidified by addition of 1 N hydrochloric acid, diethyl ether was added. The resulting mixture was transferred to a separatory funnel and the phases were separated. The organic layer was dried over MgSO₄ and filtered. The solvent was removed from the filtrate in vacuo with a bath temperature under 20° C. to yield 160 mg of 1-bromo-2-(2-(carboxy)-ethyl-cyclopropene that was >70% pure as an oil.

### Example 47

### Preparation of 1-Octyl-3-carboxy-cyclopropene (Compound 78)

a. 1-Octyl-3-(carboxyethoxy)-cyclopropene

1-Octyl-3-(carboxyethoxy)-cyclopropene was prepared from 1-decyne and ethyl diazoacetate by the method of Mueller, P.; Pautex, N.; Helv. Chim Acta 1990, 73, 1233.

b. 1-Octyl-3-carboxy-cyclopropene

1-Octyl-3-(carboxyethoxy)-cyclopropene (1.12 g, 5 mmol) and 100 ml of 0.2 N potassium hydroxide were stirred at room temperature for one week. Ether was added and the phases were separated. The aqueous phase was acidified and extracted with methylene chloride. The organic phase was dried over magnesium sulfate and stripped to give 0.8 g of 1-octyl-3-carboxy-cyclopropene.

### Example 48

### Preparation of 1-Trimethylsilyl-2,3,3-trimethylcyclopropene (Compound 79)

Compound 79 was prepared as a 36% solution in ether from 2-bromo-3-methyl-2-butene by the same method used to prepare Compound 5 from 2-bromodec-1-ene.

### Example 49

### Preparation of 1-(Butyldimethylsilyl)-2-methylcyclopropene (Compound 80)

Compound 80 was prepared from 2-bromopropene by the same method used to prepare Compound-5 from 2-bromodec-1-ene.

### Example 50

### Preparation of 1-Triethylsilyl-2-methylcyclopropene (Compound 81)

Compound 81 was prepared from 2-bromopropene by the same method used to prepare Compound 5 from 2-bromodec-1-ene.

### Example 51

### Preparation of 1-(7-T-butyldimethylsilyloxyheptyl)-cyclopropene (Compound 82)

a. 1-(7-Hydroxyheptyl)-cyclopropene

1-(7-Hydroxyheptyl)-cyclopropene was prepared by the same method already described in example 7.

b. 1-(7-T-butyldimethylsilyloxyheptyl)-cyclopropene

To a solution of 1-(7-hydroxyheptyl)-cyclopropene (1.07 g, 3.47 mmol) in 19.4 ml methylene chloride, was added t-butyldimethylsilyl chloride (.562 g, 3.75 mmol) and N,N-dimethylaminopyridine (0. 213 g, 1.74 mmol) and triethylamine (0.368 ml, 2.64 mmol.) After the reaction mixture stirred at room temperature for 2 hours, N,N-dimethylaminopyridine (.213g, 1.74 mmol) and triethylamine (.368ml, 2.64 mmol) were added. After an additional 45 minutes, the reaction was quenched by the addition of about 3 ml saturated aqueous ammonium chloride. The phases were separated. The isolate organic layer was washed sequentially with brine, saturated aqueous sodium bicarbonate and water. The organic layer was again separated, dried over magnesium sulfate and concentrated in vacuo to yield 1.2 g. This residue was purified by column chromatography with 5% ethyl acetate/hexanes to give 440 mg (47% of theoretical) of 1-(7-t-butyldimethylsilyloxyheptyl)-cyclopropene as an oil.

### Example 52

### Preparation of 1-(Methanesulfonyloxymethyl)-2-ethylcyclopropene (Compound 83)

a. 1,1,2-Tribromo-2-ethylcyclopropane

1,1,2-Tribromo-2-ethylcyclopropane was prepared from 2-bromo-1-butene by the same method used in example 5.

b. 1-(Hydroxymethyl)-2-ethylcyclopropene

A solution of 3.0 g (10 mmol) of 1,1,2-tribromo-2-ethylcyclopropane in 50 ml of ether, was cooled to −78° C. Methyllithium (1.4M, 21.4 ml, 30 mmol) was added. The reaction mixture was warmed to 5° C. Solid paraformaldehyde (1.20 g, 40 mmol) was added, and the reaction mixture was stirred at 5° C. for 1 hour, then allowed to warm to room temperature and stirred an additional hour. The reaction was quenched with water and the phases were separated. The ether phase was washed with water, washed with brine, dried over magnesium sulfate and stripped to give 900 mg of 1-(hydroxymethyl)-2-ethylcyclopropene as a yellow oil.

a. 1-(Methanesulfonyloxymethyl)-2-ethylcyclopropene

To a solution of 0.70g (7.13 mmol) of 1-(hydroxymethyl)-2-ethylcyclopropene (Compound 3) and 2 ml of triethylamine in 15 ml of ether in an ice bath, was added 0.86 g (7.5 mmol) of methanesulfonyl chloride. The reaction mixture was held 1.5 hours, then quenched with water. The phases were separated. The ether phase was washed with water, washed with brine, dried over magnesium sulfate and stripped to give 840 mg of 1-(methanesulfonyloxymethyl)-2-ethylcyclopropene as a yellow oil.

### Example 53

### Preparation of 1-(Diethoxy-thioiphosphorylthiomethyl)-2-ethylcyclopropene (Compound 84)

a. 1-(Methanesulfonyloxymethyl)-2-ethylcyclopropene

1-(Methanesulfonyloxymethyl)-2-ethylcyclopropene was prepared from 1-(hydroxymethyl)-2-ethylcyclopropene by the same method used in example 13.

b. 1-(Diethoxy-thiophosphorylthiomethyl)-2-ethylcyclopropene

1-(Methanesulfonyloxymethyl)-2-ethylcyclopropene (0.66 g, 3.75 mmol) and dithiophosphoric acid O,O′-diethyl ester, potassium salt (0.84g, 3.75 mmol) were combined in 4.4 ml dimethylformamide. After the reaction mixture stirred for 4 hours, water and then diethyl ether were added. The phases were separated. The ether phase was washed twice more with water then dried over magnesium sulfate and stripped to yield 510 mg (51% of theoretical) of 1-(diethoxy-thiophosphorylthiomethyl)-2-ethylcyclopropene as an oil.

### Example 54

### Preparation of 1-(4-Methanesulfonyloxybutyl)-cyclopropene (Compound 85)

a. 5,6-Dibromo-hexan-1-ol

To an ice bath cooled solution of 5-hexen-1-ol (11.23 g, 112.3 mmol) in about 20 ml methylene chloride was added bromine (5.80 ml plus 12 drops, 112.3+mmol) in about 20 ml methylene chloride. At the completion of the addition, the mixture is dried in vacuo to yield 29.1 g of 5,6-dibromo-hexan-1-ol.

b. 5-Bromo-hex-5-en-1-ol

To an ice bath cooled solution of 5,6-dibromo-hexan-1-ol (29.1 g, 112 mmol) in about 59 ml tetrahydrofuran was added 20% potassium t-butoxide in tetrahydrofuran (62.4g, 112 mmol.) At the completion of the addition the reaction was warmed to room temperature and stirred for about 30 minutes. Diethyl ether and water were added then the phases were separated. The isolated organic layer was dried over magnesium sulfate then dried in vacuo. This residue was purified by vacuum distillation using a 5 perforated plate column to yield 23.16 g of 87% pure 5-bromo-hex-5-en-1-ol.

c. 4-Methyl-benzoic acid 5-bromo-hex-5-enyl ester

To a solution of 5-bromo-hex-5-en-1-ol (4.39 g, 24.5 mmol) in 10.6 g methylene chloride were added 4-toluoylchloride (3.95 g, 25.6 mmol) and triethylamine (3.3 g, 33 mmol.) After stirring about 2 hours at room temperature, the mixture was diluted with diethylether then washed with 1 N hydrochloric acid followed by brine. The phases were separated and the organic layer dried over magnesium sulfate then dried in vacuo to yield 7.3 g of 4-methyl-benzoic acid 5-bromo-hex-5-enyl ester.

d. 4-Methyl-benzoic acid 4-(1,2,2-tribromo-cyclopropyl)-butyl Ester

4-Methyl-benzoic acid 5-bromo-hex-5-enyl ester (7.3 g, 24.6 mmol), N,N′-dibenzyl-N, N, N′,N′-tetramethylethylenediammonium dibromide (0.30 g, 0.66 mmol), methylene chloride (25 g), bromoform (25 g, 98.9 mmol) and 45% aqueous potassium hydroxide (11.5 g, 92 mmol) were charged to a round bottomed flask and stirred at room temperature for 4 days. After water was added, the layers were separated. To the isolated organic layer was added N,N′-dibenzyl-N, N, N′,N′-tetramethylethylenediarnnonium dibromide (0.30 g, 0.66 mmol), bromoform (27 g, 107 mmol) and 45% aqueous potassium hydroxide (12 g, 96 mmol.) After stirring at room temperature for an additional day, water and hexanes were added. The mixture was gravity filtered through qualitative filter paper and the layers were separated. The isolated organic layer was dried over magnesium sulfate then dried in vacuo. This residue was purified by column chromatography using ethyl acetate/hexanes to give 4.9 g of 61% pure 4-methyl-benzoic acid 4-(1,2,2-tribromo-cyclopropyl)-butyl ester.

e. 4-(1,2,2-Tribromo-cyclopropyl)-butan-1-ol

To a solution of 4-methyl-benzoic acid 4-(1,2,2-tribromo-cyclopropyl)-butyl ester (45.5 g, 97 mmol) in 250 g of methanol was added 50% aqueous potassium carbonate (30 g, 107 mmol) and 30 g water. The reaction was heated to 60° C. for about 2 hours then cooled to room temperature. After about 15 hours, 50% aqueous potassium carbonate (30 g, 107 mmol) and 30 g water were added and the reaction was heated to 60° C. for about 2 hours then cooled to room temperature. The reaction mixture was concentrated in vacuo, then the resulting residue was extracted with diethyl ether. The organic layer was washed with basified water (pH10 .) The phases were separated and the organic phase was dried over magnesium sulfate then dried in vacuo. This residue was purified by column chromatography using diethyl ether/hexanes to give 14.5 g of 74% pure 4-(1,2,2-tribromo-cyclopropyl)-butan-1-ol.

f. 1-(4-Hydroxybutyl)-cyclopropene

A solution of 4-(1,2,2-tribromo-cyclopropyl)-butan-1-ol (5.11 g, 14.5mmol) in 4 ml of diethylether was placed under a nitrogen atmosphere and cooled to 0° C. Using a syringe, 1.4 M methyllithium in diethylether (41.6 ml, 58.2 mmol) was added. After 15 minutes, the reaction was quenched by the addition of about 2 ml water. The phases were separated. The isolated organic layer was dried over magnesium sulfate and dried in vacuo to yield 2.51 g of 1-(4-hydroxybutyl)-cyclopropene as an oil.

g. 1-(4-Methanesulfonyloxybutyl)-cyclopropene

A solution of 1-(4-hydroxybutyl)-cyclopropene (2.43 g, 21.6 nmrol) in about 10 ml methylene chloride was cooled in a −20° C. bath. To this mixture were added triethylamine (3.32 ml, 23.7 mmol) and methanesulfonyl chloride (1.67 ml, 21.6 mmol). After about an hour, water was added to the reaction and then the phases were separated. The isolated organic layer was dried over magnesium sulfate and dried in vacuo. To this residue were added about 8 ml methylene chloride, triethylamine (1.39 ml, 10 mmol) and methanesulfonyl chloride (0.701 ml, 9.1 mmol). After about an hour, water was added to the reaction and then the phases were separated. The isolated organic layer was dried over magnesium sulfate and dried in vacuo to yield 2.9g of 70% pure 1-(4-methanesulfonyloxybutyl)-cyclopropene as an oil.

### Example 55

### Preparation of 2-Octyl-1-boronic acid)-cyclopropene (Compound 86)

A solution of 1.30 g (3.3 mmol) of 2-octyl-1,1,2-tribromiocyclopropane (example 5) in 20 ml of ether was cooled to −78° C. Methyllithium (1.4M, 5.9 ml, 8.3 mmol) was added, and the reaction mixture was stirred for 10 min, then placed in an ice bath and held for 30 minutes, then recooled to −78° C. Triisopropylborate (0.9 ml, 3.9 mmol) was added, and the reaction mixture was stirred for 15 minutes, then warmed to 0° C . Water, ether and 1N aqueous HCl (enough to make the solution acidic) were added. The phases were separated. The ether phase was washed with water, washed with brine, dried over magnesium sulfate and stripped. The product was redissolved in ether and extracted three times with 1N aqueous sodium hydroxide solution. The aqueous extracts were acidified with 6N aqueous hydrochloric acid and extracted three times with ether. The ether phase was washed with water, washed with brine, dried over magnesium sulfate and stripped to give 400 mg of pale yellow solid 2-octyl-1-(boronic acid)-cyclopropene.

### Example 56

### Preparation of 2-Methyl-1-(boronic acid, monoisopropyl eester)-cyclopropene (Compound 87)

A solution of about 2 mg 1,10-phenanthroline in about 50 ml diethyl ether was cooled to 40° C. and placed under a nitrogen atmosphere. To this was added via syringe diisopropylamine (3.33 ml, 23.8 mmol) and 1-methylcyclopropene (1.90 ml, 27.8 mmol; prepared from 3-chloro-2-methyl-propene; see Hopf, H.; Wachholz, G.; Walsh, R. Chem. Ber. 1985, 118, 3579 and Koster, R. et al. Liebigs Annalen Chem. 1973, 1219-1235) Then 1.7 ml N-butyllithium (1.6M in hexane) was added until a brown color remained. This was followed by another portion of the same butyllithium (14.9 ml, 23.8 mmol.) After stirring at −40° C. for 15 minutes, triisopropylborate (4.60 ml, 19.8 mmol) was added. After about 10 minutes, added 12 ml 6 N hydrochloric acid. After stirring at −10° C. for 15 minutes, the phases were separated. The isolated organic layer was dried over magnesium sulfate then concentrated in vacuo to give 3.5 g of 2-methyl-1-(boronic acid, monoisopropyl ester)-cyclopropene as an oil.

In a similar manner the following compounds were made:

TABLE 1
Additional compounds

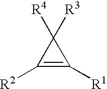

| Cmpd | | | | | Purity | |
|---|---|---|---|---|---|---|
| # | R¹ | R² | R³ | R⁴ | % | Comments |
| 16 | H | H | 4- | CH₃ | 30 | 30% 1-(4- |
| | | | Methoxy- | | | methoxyphenoxymethyl)-1- |
| | | | phenoxy- | | | methylcyclopropane |
| | | | methyl | | | |
| 17 | benzyl | H | H | H | | |
| 18 | phenethyl | H | H | H | | |
| 19 | H | H | phenethyl | CH₃ | 55 | 36% 1-phenethyl-1- |
| | | | | | | methylcyclopropane |
| 20 | H | H | benzyl | CH₃ | 50 | 24% 1-benzyl-1- |
| | | | | | | methylcyclopropane |
| 21 | 2-cyclohexyl- | H | H | H | | |
| | ethyl | | | | | |
| 22 | cycloheptyl- | H | H | H | | |
| | methyl | | | | | |
| 23 | cyclohexyl- | H | H | H | | |
| | methyl | | | | | |
| 24 | 4-methylbenzyl | H | H | H | | |
| 25 | 3-phenylpropyl | H | H | H | | |
| 26 | 2-methoxy- | H | H | H | | |
| | benzyl | | | | | |
| 27 | 4-phenylbutyl | H | H | H | | |
| 28 | 2-(4-chloro- | H | H | H | 72 | |
| | phenyl)ethyl | | | | | |
| 29 | 3-methylbenzyl | H | H | H | | |
| 30 | 2,4,6-trimethyl- | H | H | H | 40 | 49% 3-(2,4,6-trimethylphenyl)- |
| | benzyl | | | | | 2-bromopropene |
| 31 | cyclopentyl- | H | H | H | | |
| | methyl | | | | | |
| 32 | 7-(1-pyrazole)- | H | H | H | | |
| | heptyl | | | | | |
| 33 | 3-(2-(1,3- | H | H | H | 75 | 10% of the |
| | dioxolane))- | | | | | tribromocyclopropane |
| | propyl | | | | | precursor |
| 34 | 7-(1-(1,2,4- | H | H | H | | |
| | triazole))-heptyl | | | | | |
| 35 | 2-(2- | H | H | H | | |
| | pyridylthio)- | | | | | |
| | ethyl | | | | | |
| 42 | 2-(4,6- | H | H | H | | |
| | dimethylpyrimid- | | | | | |
| | 2-yl)-ethyl | | | | | |
| 43 | 2-(4- | H | H | H | 50 | 50% ethyl acetate |
| | pyridylthio)- | | | | | |
| | ethyl | | | | | |
| 48 | 2-(3- | H | H | H | | |
| | furylcarbonyloxy)- | | | | | |
| | ethyl | | | | | |
| 49 | 2-(benzofuran- | H | H | H | | |
| | 2-ylcarbonyloxy)- | | | | | |
| | ethyl | | | | | |
| 50 | 2-(5,6- | H | H | H | | |
| | dichloropyrid-3- | | | | | |
| | ylcarbonyloxy)- | | | | | |
| | ethyl | | | | | |
| 51 | 2-(4-methyl- | H | H | H | | |
| | 1,2,3- | | | | | |
| | thiadiazol-5- | | | | | |
| | ylcarbonyloxy)- | | | | | |
| | ethyl | | | | | |
| 52 | 2-(N-t-BOC- | H | H | H | | |
| | isothiazolidin- | | | | | |
| | 4-ylcarbonyloxy)- | | | | | |
| | ethyl | | | | | |
| 54 | 7-(2- | H | H | H | | |
| | tetrahydrofuryl- | | | | | |
| | carbonyloxy)- | | | | | |
| | heptyl | | | | | |
| 61 | 3-(pyrazin-2-yl | H | H | H | 50% | 50% solvent |
| | carbonyloxy)- | | | | | |
| | propyl | | | | | |
| 62 | 2-(4-(1H- | H | H | H | | |
| | pyrrol-1-ylphenyl) | | | | | |
| | carbonyloxy)- | | | | | |
| | -ethyl | | | | | |

The compounds were characterized using a variety of spectroscopic techniques. The NMR data for compounds 1-35 is given in Table 2. For compounds containing impurities, the chemical shifts of the impurities are not reported, and the integrals are adjusted to reflect only the contribution of the target compound.

TABLE 2
NMR Data

| cmpd # | NMR |
|---|---|
| 1 | (CDC13): 1.0(d, 2H), 3.8(s, 2H), 6.6(m, 1H), 7.2(d, 2H), 7.25 |
| | (d,2 H) |
| 2 | (CDC13): 1.0(d, 2H), 4.0(s, 2H), 6.6(m, 1H), 6.95(d, 1H), |
| | 7.0(m, 1H), 7.2(d, 1H) |
| 3 | (CDC13): 0.88(d, 2H), 1.3(d, 2H), 1.5-1.8(m, 2H), 2.0-2.2(m, |
| | 2H), 2.5(m, 2H), 3.7-3.9(m, 2H), 4.1-4.2(m, 2H), 4.55(m, 1H), |
| | 6.5(m, 1H) |
| 4 | (CDC13): 0.25(s, 6H), 0.7-0.8(m, 2H), 0.87(d, 2H), 1.2-1.4(m, |
| | 6H), 1.5-1.7 (m, 2H), 2.45(t, 2H), 6.45(bs, 1H), 7.3-7.45(m, |
| | 3H), 7.45-7.6(m, 2H) |
| 5 | (CDC13): 1.05(s, 2H), 1.53(s, 6H), 6.5(s, 1H), 7.1-7.5(m, 5H). |
| 6 | (d6 Acetone): 1.6(s, 3H), 7.1-7.3(m, 5H), 7.45(s, 2H) |
| 7 | (CDC13): 1.3(s, 3H), 3.9(s, 2H), 6.8-7.0(m, 3H), 7.25(m, 2H), |
| | 7.35(s, 2H) |
| 8 | (CDC13): 0.89(2H, s), 2.03(3H, s), 3.75(2H, s), 7.1-7.4(5H, m) |
| 9 | (CDC13): 0.94(d, 2H), 2.8(t, 2H), 3.1(t, 2H), 6.6(m, 1H), 7.3(m, |
| | 4H) |
| 10 | (CDC13): 0.85(d, 2H), 2.8(t, 2H), 4.3(t, 2H), 6.6(m, 1H), 7.6(m, |
| | 2H), 7.7(m, 1H), 7.9(m, 2H) |
| 11 | (CDC13): 0.92(d, 2H), 1.58(s, 4H), 3.05(t, 2H), 4.55(t, 2H), 6.6 |
| | (bs, 1H), 7.39(s, 1H), 7.47(s, 1H) |
| 12 | (CDC13): 0.87(d, 2H), 1.2-1.4(m, 6H), 1.57(m, 2H), 1.79(m, |
| | 2H), 2.47(td, 2H), 3.92(t, 2H), 6.44(m, 1H), 6.90(bs, 1H), 7.06 |
| | (bs, 1H), 7.46(bs, 1H) |
| 13 | (CDC13): 0.87(d, 2H), 1.2-1.4(m, 6H), 1.5-1.8(m, 4H), 2.47(t, |
| | 2H), 3.67(t, 2H), 6.42(bs, 1H), 6.9-7.1(m, 6H), 7.2-7.4(m, 4H) |
| 14 | (CDC13): 0.88(d, 2H), 1.2-1.5(m, 5H), 1.55-2.0(m, 5H), 2.4- |
| | 2.6(m, 2H), 6.40(t, 1H) |
| 15 | (CDC13): 0.90(d, 2H), 2.6-2.9(m, 4H), 3.6-3.8(m, 8H), 6.5(m, |
| | 1H) |
| 16 | (CDC13): 1.2(s, 3H), 3.8(s, 3H), 3.9(s, 2H), 6.8(m, 4H), 7.35(s, |
| | 2H) |
| 17 | (CDC13): 1.1(d, 2H), 3.8(s, 2H), 6.5(m, 1H), 7.2-7.35(m, 5H) |
| 18 | (CDC13): 0.92(d, 2H), 2.8(t, 21H), 2.9(t, 2H), 6.45(m, 1H), |
| | 7.15-7.3(m, 5H) |
| 19 | (CDC13): 1.18(s, 3H), 1.78(m, 2H), 2.42(m, 2H), 7.1-7.2(m, |
| | 3H), 7.2-7.3(m, 2H), 7.3(s, 2H) |
| 20 | (CDC13): 1.17(s, 3H), 2.76(s, 2H), 7.1(m, 2H), 7.15-7.3(m, |
| | 3H), 7.35(s, 2H) |
| 21 | (CDC13): 0.89(d, 2H), 0.88-1.0, (m, 1H), 1.1-1.35(m, 4H), |
| | 1.47(q, 2H), 1.6-1.85(m, 4H), 2.48(td, 2H), 6.42(t, 1H) |
| 22 | (CDC13): 0.87(d, 2H), 1.15-1.3, (m, 2H), 1.35-1.9(m, 11H), |
| | 2.40(dd, 2H), 6.43(t, 1W) |
| 23 | (CDC13): 0.87(d, 2H), 0.9-1.05, (m, 2H), 1.1-1.35(m, 3H), |
| | 1.4-1.8(m, 6H), 2.37(dd, 2H), 6.40(t, 1H) |
| 24 | (CDC13): 1.0(d, 2H), 2.3(s, 3H), 3.8(s, 2H), 6.56(m, 1H), 7.1 |
| | (m, 4H) |
| 25 | (CDC13): 0.9(d, 2H), 1.9(m, 2H), 2.45(t,2H), 2.6(t, 2H), 6.5(m, |
| | 1H), 7.1-7.3(m, 5H) |
| 26 | (CDC13): 1.0(d, 2H), 3.8(s, 3H), 6.55(m, 1H), 6.9(m, 2H), 7.2 |
| | (m, 2H) |
| 27 | (CDC13): 0.88(d, 2H), 1.6-1.75(m, 4H), 2.55(t, 2H), 2.65(t, |
| | 2H), 6.4(m, 1H), 7.15(m, 3H), 7.25(m, 2H) |
| 28 | (CDC13): 0.9(d, 2H), 2.7-2.8(m, 2H), 2.8-2.9(m, 2H), 6.5(m, |
| | 1H), 7.15(d, 2H), 7.3(d, 2H) |
| 29 | (CDC13): 1.0(d, 2H), 2.3(s, 3H), 3.8(s, 2H), 6.58(m, 1H), 7.1 |
| | (m, 3H), 7.2(m, 1H) |
| 30 | (CDC13): 0.9(d, 2H), 2.25(m, 9H), 3.75(s, 2H), 6.45(m, 1H), |
| | 6.85(s, 1H) |
| 31 | (CDC13): 0.89(d, 2H), 1.1-1.3(m, 2H), 1.45-1.65(m, 4H), |
| | 1.65-1.85(m, 2H), 2.15(m, 1H), 2.45(d, 2H), 6.44(m, 1H) |
| 32 | (CDC13): 0.87(d, 2H), 1.2-1.4(m, 6H), 1.56(pentet, 2H), 1.87 |
| | (pentet, 2H), 2.46(td, 2H), 4.12(t, 2H), 6.23(t, 1H), 6.42(t, 1H), |
| | 7.36(d, 1H), 7.50(d, 1H) |
| 33 | (CDC13): 0.89(d, 2H), 1.7(m, 4H), 2.5(m, 2H), 3.8-4.0(m, 4H), |
| | 4.9(m, 1H), 6.47(m, 1H) |
| 34 | (CDC13): 0.87 (d, 2H), 1.2-1.4(m, 6H), 1.57(m, 2H), 1.88(m, |
| | 2H), 2.47(t, 2H), 4.17(t, 2H), 6.43(bs, 1H), 7.94(s, 1H), 8.04(s, |
| | 1H) |
| 35 | (CDC13): 0.97(d, 2H), 2.9(t, 2H), 3.4(t, 2H), 6.6(m, 1H), 6.98 |
| | (m, 1), 7.16(m, 1H), 7.49m, 1H), 8.4(m, 1H) |
| 36 | (CDC13): 0.9(d, 2H), 1.2-1.9(m, H), 2.25(m ,2H), 2.45(m, 2H), |
| | 2.9(t, 4H), 6.45(m, 1H), 6.95(m, 1H) |
| 37 | (CDC13): 0.8-1.2(m, 5H), 2.3(q, 2H), 5.1(s, 3H), 7.0-7.5(m, |
| | 4H) |
| 38 | (CDC13): 0.9(m, 5H), 1.2-1.8(m, 14H), 2.6(t, 2H), 4.0-4.2(m, |
| | 4H) |
| 39 | (CDC13): 1.04(d, 2H), 2.10(s, 3H), 2.2(d, 1H), 3.8(s, 3H), 5.65 |
| | (bs, 1H), 6.85(d, 1H), 6.9(m, 2H), 7.3(d, 1H) |
| 41 | (CDC13): 7.5(m, 3H), 7.7(m, 2H) |
| 42 | (CDC13): 0.97(d, 2H), 2.4(s, 6H), 2.95(t, 2H), 3.4(t, 2H), 6.55 |
| | (m, 1H), 6.7(s, 1H) |
| 43 | (CDC13): 0.9(d, 2H), 2.9(t, 2H), 3.3(t, 2H), 6.65(m, 1H), 7.15 |
| | (m, 2H), 8.45 (m, 2H) |
| 44 | (CDC13): 0.9(d, 2H), 1.55-1.9(m, 6H), 2.4(s, 3H), 4.3(t, 2H), |
| | 6.5(m, 1H), 7.2(d, 2H), 7.9(d, 2H) |
| 45 | (CDC13): 1.6(s, 2H), 3.81(s, 2H), 7.2-7.4(m, 5H) |
| 46 | (CDC13): 1.6(s, 2H), 3.8(s, 2H), 7.2-7.4(m, 5H) |
| 47 | (CDC13): 0.9(d, 2H), 2.95(t, 2H), 4.7(d, 2H), 6.5(m, 1H), 6.6 |
| | (m, 1H), 7.2 (m, 1H),7.6(M, 1H) |
| 48 | (CDC13): 0.95(d, 2H), 2.9(t, 2H), 4.5(t, 2H), 6.6(m, 1H), 6.7(d, |
| | 1H), 7.4(d, 1H), 8.0(s, 1H) |
| 49 | (CDC13): 0.99(d, 2H), 3.05(t, 2H), 4.65(t, 2H), 6.7(m, 1H), |
| | 7.3-7.8(m, 5H) |
| 50 | (CDC13): 0.9(d, 2H), 2.98(t, 2H), 4.61(t, 2H), 6.7(m, 1H), 8.35 |
| | (s, 1H), 8.9 (s, 1H) |
| 51 | (CDC13): 0.9(d, 2H), 3.0(m, 5H), 4.6(t, 2H), 6.7(m, 1H) |
| 52 | (CDC13): 0.9(d, 2H), 1.4(d, 9H), 2.8(t, 2H), 3.2-3.5(m ,2H), |
| | 4.7-4.9(m, 5H), 6.6(m, 1H) |
| 53 | (CDC13): 0.88(d, 2H), 1.2-1.9(m, 10H), 2.48(t, 2H), 3.08(s, |
| | 3H), 4.36 (t, 2H), 6.45 (m, 1H), 8.03(d, 2H), 8.23(d, 2H) |
| 54 | (CDC13): 0.95(d, 2H), 1.2-1.4(m, 6H), 1.5-1.7(m, 4H), 1.8-2.1 |
| | (m, 4H), 2.5(t, 2H), 3.9-4.2(m, 4H), 4.5(m, 1H), 6.45(m, 1H) |
| 55 | (CDC13): 0.9(d, 2H), 2.05(m, 2H), 2.7(m, 2H), 3.2(m, 2H), 6.5 |
| | (m, 1H), 7.0(t, 1H), 7.2(d, 1H), 7.5(t, 1H), 8.4(d, 1H) |
| 56 | (CDC13): 0.9(d, 2H), 1.3-1.75(m, 8H), 2.4-2.55(m, 4H), 3.6(m, |
| | 2H), 4.1(t, 2H),6.45(m, 1H), 7.5-7.7(m, 3H), 7.9(m, 2H) |
| 57 | (CDC13): 0.9(d, 2H), 1.3-1.7(m, 14H), 2.0(s, 3H), 3.65(t, 2H), |
| | 6.45(m, 1H), 7.1(d, 2H), 7.25(d, 2H) |
| 58 | (CDC13): 0.9(d, 2H), 1.3-1.8(m, 12H), 2.4(m, 2H), 3.2(t, 2H), |
| | 6.45(m, 1H), 7.25(s, 1H), 8.15(s, 1H) |
| 59 | (CDC13): 0.9(d, 2H), 1.3(m, 2H), 2.6(t, 2H), 3.95(s, 3H), 4.3(t, |
| | 2H), 6.1(m, 1H), 6.5(m, 1H), 6.8(m, 1H), 6.95(m, 1H) |
| 60 | (CDC13): 0.97(t, 3H), 1.1(s, 2H), 2.4(m, 2H), 5.2(s, 2H), 7.05 |
| | (d, 1H), 7.45(d, 2H), 7.7(d, 1H), 7.74(d, 2H) |
| 61 | (CDC13): 0.95(d, 2H), 2.1(m, 2H), 2.7(t, 2H), 4.5(t, 2H), 6.55 |
| | (m, 1H), 8.7(d, 2H), 9.32(s, 1H) |
| 62 | (CDC13): 0.9(d, 2H), 2.9(t, 2H), 4.55(t, 2H), 6.35(m, 2H), 6.65 |
| | (m, 1H), 7.15(m, 2H), 7.45(d, 2H), 8.1(d, 2H) |
| 63 | (CDC13): 0.55(g, 6H), 0.88(d, 2H), 0.94(t, 9H), 1.99(s, 2H), |
| | 6.25(bs, 1H). |
| 64 | (CDC13): 0(s, 9H), 0.82(d, 2H), 1.91(s, 2H), 6.22(bs, 1H). |
| 65 | (CDC13): 0(s, 9H), 0.45-0.65(m, 2H), 0.91(d, 2H), 1.25-1.5(m, |
| | 6H), 1.60(pentet, 2H), 2.50(td, 2H), 6.45(t, 1H). |
| 66 | (CDC13): 0(s, 9H), 0.79(m, 2H), 0.90(d, 2H), 2.48(td, 2H), 6.37 |
| | (t, 1H). |
| 67 | (CDC13): 0.09(s, 9H), 0.65(s, 2H), 0.82(t, 3H), 1.2-1.4(m, |
| | 10H), 1.55(pentet, 2H), 2.47(t, 2H). |
| 68 | (CDC13): 0.98(d, 2H), 2.96(td, 2H), 3.04(s, 3H), 4.47(t, 2H), |
| | 6.75(bs, 1H). |
| 69 | (CDC13): 0.88(d, 2H), 1.2-1.45(m, 6H), 1.6(pentet, 2H), 1.75 |
| | (pentet, 2H), 2.45(td, 2H), 3.00(s, 3H), 4.23(t, 2H), 6.4(t, 1H). |
| 70 | (CDC13): 0.88(d, 2H), 1.25(t, 3H), 1.25-1.45(m, 6H), 1.5-1.75 |
| | (m, 4H), 2.4-2.65 (m, 6H), 6.43(t, 1H). |
| 71 | (CDC13): 0.88(t, 3H), 1.2-1.4(m, 10H), 1.5(s, 2H), 1.6(m, 2H), |
| | 2.4(t, 2H) |
| 72 | (CDC13): 0.9(t, 3H), 1.15(s, 3H), 1.15-1.5(m, 6H), 1.7(m, 2H), |
| | 7.35(s, 2H) |
| 73 | (CDC13): 0.9(t, 3H), 1.1(s, 3H), 1.15-1.5(m, 16H), 7.34(s, 2H) |
| 74 | (CDC13): 0.77(s, 2H), 0.9(t, 3H), 1.15-1.4(m, 8H), 1.55(m, |
| | 2H), 2(t, 3H), 2.35(m, 2H) |
| 75 | (CDC13): 1.55(s, 2H), 2.1(s, 3H), 2.75(m, 2H), 2.8(m, 2H), |
| | 5.77(s, 2H) |
| 76 | (CDC13): 1.3(t, 3H), 1.55(s, 2H), 2.6(t, 2H), 2.8(t, 2H), 4.1(q, |
| | 2H) |
| 77 | (CDC13): 1.56(s, 2H), 2.65(t, 2H), 2.8(t, 2H) |
| 78 | (CDC13): 0.88(t, 3H), 1.1-1.5(m, 10H), 1.6(pentet, 2H), 2.13(d, |
| | 2H), 2.51 (t, 2H), 6.33(bs, 1H). |
| 79 | (CDC13): 0(s, 9H), 0.95(s, 6H), 1.96(s, 3H). |
| 80 | (CDC13): 0.16(s, 6H), 0.67(t, 2H), 0.75(s, 2H), 0.91(t, 3H), |
| | 1.25-1.45(m, 2H), 2.25(s, 3H). |
| 81 | (CDC13): 0.64(q, 6H), 0.74(s, 2H), 0.95(t, 9H), 2.24(s, 3H). |
| 82 | (CDC13): 0(s, 6H), 0.84(m, 11H), 1.2-1.6(m. 10H), 2.45(t, 2H), |
| | 3.55(t, H), 6.45(m, 1H) |
| 83 | (CDC13): 1.12(s, 2H), 1.20(t, 3H), 2.53(q, 2H), 3.05(s, 3H), |
| | 5.18 (s, 2H). |
| 84 | (CDC13): 0.9(s, 2H), 1.3(t, 3H), 1.4(t, 6H), 2.5(m, 2H), 3.9(d, |
| | 2H), 4.1-4.4(m, 4H) |
| 85 | (CDC13): 0.9(d, 2H), 1.7-1.9(m, 4H), 2.6 (t, 2H), 3.0 (s, 3H), |
| | 4.3(t, 2H), 6.5 (m, 1H) |
| 86 | (CDC13): 0.88(s, 2H, and t, 3H), 1.2-1.4(m, 8H), 1.5-1.7(m, |
| | 4H), 2.61(t, 2H), 4.53(br.s, 2H). |
| 87 | (d6DMSO): 0.7(d, 2H), 1.1(d, 6H), 2.2(d, 3H), 3.8(m, 1H), 8.05 |
| | (br.s, 1H) |

Biological Activity:

### Tomato Epinasty Test

Objective: The test procedure is designed to determine the ability of an experimental compound to block the epinastic growth response induced by ethylene in tomato plants when the experimental compound is administered either as a volatile gas or as a component of a spray solution.

Treatment chambers are of an appropriate size for the test plants and are airtight. Each is fitted with a reusable septum to be used for injection of ethylene. Test plants are Patio variety tomato seedlings planted two plants per three inch square plastic pot.

Volatile gas treatment entails placing two pots of Patio var. tomatoes into a polystyrene 4.8L volume treatment chamber along with one-half (upper or lower section) of a 50×9 mm plastic Petri dish containing a Gelman filter pad. The appropriate amount of experimental compound, dissolved in 1.0 ml acetone, is pipetted onto the filter pad and the chamber immediately sealed. Four hours later ethylene gas equal to 10 ppm v/v final concentration is injected into the sealed chamber. Sixteen hours later the chambers are opened in an exhaust hood, allowed to air and the plants scored visually for the degree of protection against ethylene-induced epinasty conferred by the experimental compound when compared to ethylene treated and untreated controls on a scale of 0 to 10. A rating of 10 means complete protection. A rating of 0 means no protection from the effects of ethylene. Gas treatment concentrations are volume/volume.

Spray application treatment entails using a DeVilbiss atomizer to completely cover all foliage and stems of two pots of Patio var. tomato plants with the appropriate amount of experimental compound dissolved in 10% acetone/90% water with 0.05% Silwett L-77 surfactant. Plants are air-dried in a drying hood for four hours then transferred to a 4.8 L polystyrene chamber which is sealed.

Ethylene gas equal to 10 ppm v/v fmal concentration is injected into the sealed chamber. Sixteen hours later the chambers are opened in an exhaust hood, allowed to air and the plants scored visually for the degree of protection against ethylene-induced epinasty conferred by the experimental compound when compared to ethylene treated and untreated controls on a scale of 0 to 10. A rating of 10 means complete protection. A rating of 0 means no protection from the effects of ethylene.

The activity of the compounds of this invention in the tomato epinasty test when applied as a gas a spray is given in Table 3.

TABLE 3
Activity of the compounds of this invention in the tomato epinasty test.

| Cmpd# | Gas @ 1000 ppm | Gas @ 10 ppm | Spray @ 10 ppm |
|---|---|---|---|
| 1 | NT | 10 | 10 |
| 2 | NT | 10 | 7 |
| 3 | NT | 8 | 0 |
| 4 | NT | 4 | 10 |
| 5 | NT | 5 | 2 |
| 6 | 7 | 2.5 | 1 |
| 7 | 10 | 4 | 2 |
| 8 | 10 | 0 | 0 |
| 9 | NT | 10 | 10 |
| 10 | NT | 10 | 10 |
| 11 | 8^{a} | 2 | 0 |
| 12 | 10^{b} | 55 | 35 |
| 13 | NT | 0 | 10 |
| 14 | NT | NT | NT |
| 15 | NT | 10 | 0 |
| 16 | 10^{c} | 3.75 | 4.5 |
| 17 | NT | 9 | 2 |
| 18 | NT | 10 | 6 |
| 19 | 7.5 | 2 | 2 |
| 20 | 7 | 0 | 0 |
| 21 | NT | 10 | 10 |
| 22 | NT | 9 | 10 |
| 23 | NT | 10 | 10 |
| 24 | NT | 10 | 10 |
| 25 | NT | 10 | 10 |
| 26 | NT | 10 | 5 |
| 27 | NT | 10 | 10 |
| 28 | NT | 9.5 | 8 |
| 29 | NT | 10 | 10 |
| 30 | 8 | 3 | 0 |
| 31 | NT | 9 | 7.5 |
| 32 | 10 | 3 | 10 |
| 33 | NT | 8 | 0 |
| 34 | 10 | 4.5 | 9 |
| 35 | NT | 10 | 9 |
| 36 | 10^{c} | 5 | 3 |
| 37 | 2 | 0 | 0 |
| 38 | 10(@850 ppm) | 3 | 0 |
| 39 | 10 | 2 | 0 |
| 40 | NT | 7 | 0 |
| 41 | 2 | 0 | 0 |
| 42 | 3(@343.4 ppm) | NT | 2 |
| 43 | NT | 10 | 0 |
| 44 | 7 | 0 | 0 |
| 45 | 10 | 5 | 0 |
| 46 | 10 | 5 | 0 |
| 47 | 10(@551 ppm) | 0 | 0 |
| 48 | NT | 10 | NT |
| 49 | 9(@343.4 ppm) | 0 | 0 |
| 50 | 9 | 0 | 0 |
| 51 | 3 | 0 | 0(8@1000 ppm) |
| 52 | 3 | 0 | 2(10@1000 ppm) |
| 53 | 10 | 0 | 0 |
| 54 | 2 | 0 | 0 |
| 55 | 10(@800 ppm) | NT | 3 |
| 56 | NT | 5 | 10 |
| 57 | 10 | 0 | 2 |
| 58 | NT | 3 | 0 |
| 59 | NT | 3 | 4 |
| 60 | 0 | 4 | 0 |
| 61 | 10(@438 ppm) | 0 | 0 |
| 62 | 10(@509 ppm) | 0 | 0 |
| 63 | NT | 10 | 10 |
| 64 | NT | 10 | 9 |
| 65 | NT | 10 | 6 |
| 66 | NT | 10 | 10 |
| 67 | NT | 6 | 3 |
| 68 | 10 | 3 | 5 |
| 69 | 8 | 0 | 0 |
| 70 | NT | 2 | 10 |

^{a}tested at 600 ppm
^{b}tested at 850 ppm
^{c}tested at 500 ppm
NT means not tested

| | Gas @ 1000 | Gas @ 500 | Gas @ 10 | Spray @ 10 |
|---|---|---|---|---|
| Cmpd# | ppm | ppm | ppm | ppm |
| 71 | 10 | NT | 1 | 3 |
| 72 | 9 | NT | 0 | 2 |
| 73 | 8 | NT | 0 | 0 |
| 74 | 10 | NT | 0 | 0 |
| 75 | NT | NT | 10 | 0 |
| 76 | NT | NT | 10 | 0 |
| 77 | NT | NT | 8 | 2 |
| 78 | 5 | 10 | 0 | 0 |

NT means not tested

| Compound # | Gas @ 1000 ppm | Gas @ 10 ppm | Spray @ 10 ppm |
|---|---|---|---|
| 79 | NT | 10 | NT |
| 80 | 7 | 0 | 0 |
| 81 | 10 | 0 | 0 |
| 82 | 10 | 3 | 0 |
| 83 | 10 | 4 | 2 |
| 84 | 10 | 0 | 0 |
| 85 | 10 | 0 | 0 |
| 86 | NT | 10 | 0 |

NT means not tested

1. A compound of the formula: 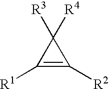
wherein:
a) one of R¹ and R³ is H and R², R⁴, and the other of R¹ and R³ are independently selected from H and a group of the formula:
—(L)ₙ—Z
wherein:
i) n is an integer from 1 to 12;
ii) each L is independently selected from a member of the group D1, D2, E, or J wherein:
D1 is of the formula: 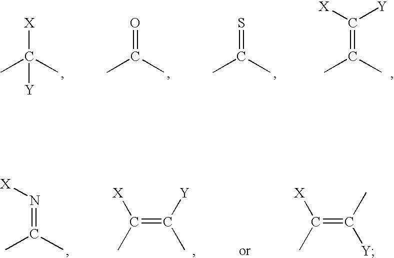
D2 is of the formula: 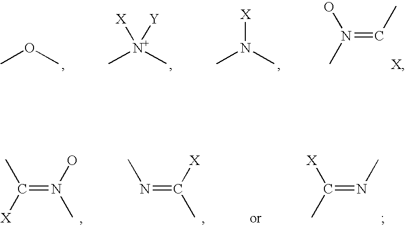
E is of the formula: 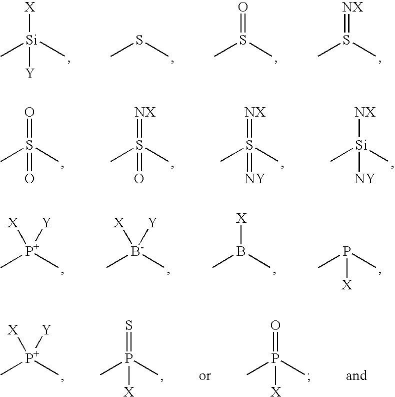
J is of the formula: 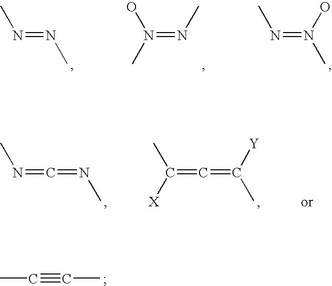
wherein:
A) each X and Y is independently a group of the formula:
—(L)ₘ—Z;
and
B) m is an integer from 0 to 8; and
C) no more than two D2 or E groups are adjacent to each other and no J groups are adjacent to each other;
iii) each Z is independently selected from:
A) hydrogen, halo, cyano, nitro, nitroso, azido, chlorate, bromate, iodate, isocyanato, isocyanido, isothiocyanato, pentafluorothio, or
B) a group G, wherein G is an unsubstituted or substituted; unsaturated, partially saturated, or saturated; monocyclic, bicyclic, tricyclic, or fused; 4 to 14 membered carbocyclic or heterocyclic ring system wherein;
1) when the ring system contains a 4 membered heterocyclic ring, the heterocyclic ring contains 1 heteroatom;
2) when the ring system contains a 5, or more, membered heterocyclic ring or a polycyclic heterocyclic ring, the heterocyclic or polycyclic heterocyclic ring contains from 1 to 4 heteroatoms;
3) each heteroatom is independently selected from N, O, and S;
4) the number of substituents is from 0 to 5 and each substituent is independently selected from X;
b) the total number of non-hydrogen atoms in each compound is 50 or less; and
c) the total number of heteroatoms in —(L)ₙ—Z is from 0 to 4; and
d) either,
i) R¹ or R³ contains at least one group G; or
ii) at least one L group is an E group; or
iii) at least one of R¹, R², R³, and R⁴ contains one to four non-hydrogen atoms and at least one of R¹, R², R³, and R⁴ contains more than four non-hydrogen atoms; andits enantiomers, stereoisomers, salts, and mixtures thereof;
or a composition thereof;
provided that:
a) —(L)ₙ—Z is other than trimethylsilyl, trimethylsilylsulfonyl or thiol; and
b) R¹ is other than phenylsulfonyl, phenylthioethyl, diphenylhydroxymethyl, benzo[g]quinolin-7-ol-1-methyl, a malonate derivative, a substituted 3-aminocyclohexenone, a dialkoxybenzylaminocarbonyl; and
c) R³ is other than 2-phenyl-ethenyl, phenylthio, (4-bromo-2-methylphenyl)carbamic acid N-carbonyl, (4-bromo-2-methylphenyl)carbamic acid ethyl ester N-carbonyl, a malonate derivative, aryloxy, or a dialkoxybenzylaminecarbonyl.

2. A method of inhibiting an ethylene response in a plant comprising the step of contacting the plant with an effective ethylene response-inhibiting amount of a cyclopropene derivative of the formula: 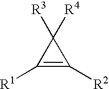
wherein:
a) one of R¹ and R³ is H and R², R⁴, and the other of R¹ and R³ are independently selected from H and a group of the formula:
—(L)ₙ—Z
wherein:
i) n is an integer from 1 to 12;
ii) each L is independently selected from ai.member of the group D1, D2, E, or J wherein:
D1 is of the formula: 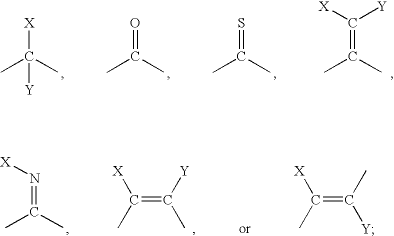
D2 is of the formula: 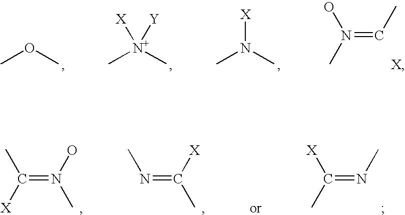
E is of the formula: 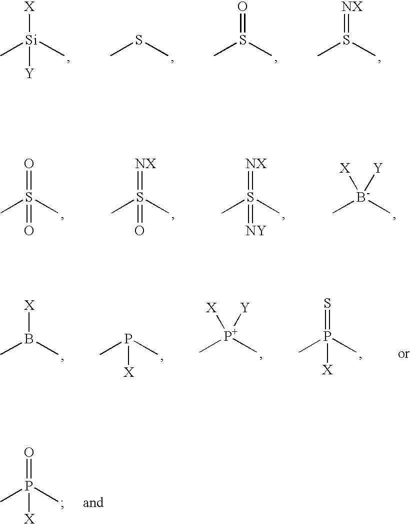
and
J is of the formula: 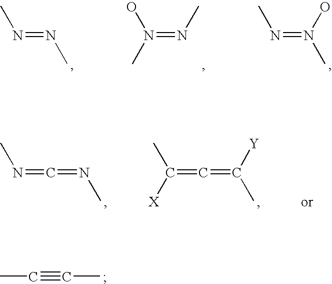
wherein:
A) each X and Y is independently a group of the formula:
—(L)ₘ—Z;
and
B) m is an integer from 0 to 8; and
C) no more than two D2 or E groups are adjacent to each other and no J groups are adjacent to each other;
iii) each Z is independently selected from:
A) hydrogen, halo, cyano, nitro, nitroso, azido, chlorate, bromate, iodate, isocyanato, isocyanido, isothiocyanato, pentafluorothio, or
B) a group G, wherein G is an unsubstituted or substituted; unsaturated, partially saturated, or saturated; monocyclic, bicyclic, tricyclic, or fused; 4 to 14 membered carbocyclic or heterocyclic ring system wherein;
1) when the ring system contains a 4 membered heterocyclic ring, the heterocyclic ring contains 1 heteroatom;
2) when the ring system contains a 5, or more, membered heterocyclic ring or a polycyclic heterocyclic ring, the heterocyclic or polycyclic heterocyclic ring contains from 1 to 4 heteroatoms;
3) each heteroatom is independently selected from N, O, and S;
4) the number of substituents is from 0 to 5 and each substituent is independently selected from X;
b) the total number of non-hydrogen atoms in each compound is 50 or less; and
c) the total number of heteroatoms in —(L)ₙ—Z is from 0 to 4; and
d) either;
i) R¹ or R³ contains at least one group G; or
ii) at least one L group is an E group; or
iii) at least one of R¹, R², R³, and R⁴ contains one to four non-hydrogen atoms and at least one of R¹, R², R³, and R⁴ contains more than four non-hydrogen atoms; andits enantiomers, stereoisomers, salts, and mixtures thereof;
or a composition thereof.

3. The method of claim 2, wherein the ethylene response is one or more of ripening or senescence of flowers, fruits, and vegetables; abscission of foliage, flowers, and fruit; the shortening of life of ornamental plants, cut flowers, shrubbery, seeds, or dormant seedlings; inhibition of growth; stimulation of growth; aauxin activity; inhibition of terminal growth; control of apical dominance; increase in branching; increase in tilleiing; changing the morphology of plants, modifying the susceptibility:to plantmpathogens such as fingi, changing bio-chemical compositions; abortion or inhibition of flowering or seed development; lodging effects; stimulation of seed germination; breaking of dormancy; hormone effects; and epinasty effects.

4. The method of claim 2, wherein R², R³, and R⁴ are hydrogen or R¹, R², and R³ are hydrogen.

5. The method of claim 2, wherein n is from 1 to 7.

6. The method of claim 2, wherein m is from 0 to 2.

7. The method of claim 2, wherein:
a) each D1 is —CXY—, —CO—, or —CS—;
b) each D2 is —NX—or —O—;
c) each E is —S—,—SiXY—, or —SO₂—;
d) each X and Y is independently H, halo, OH, SH, —C(O)(C₁-C₄)alkyl, —C(O)O(C₁-C₄)alkyl, —O—(C₁-C₄)alkyl, —S—(C₁-C₄)alkyl, or substituted or unsubstituted (C₁-C₄)alkyl; and
e) each Z is independently H, halo, or G.

8. The method of claim 2, wherein each G is independently a substituted or unsubstituted; five, six, or seven membered; aryl, heteroaryl, heterocyclyl, or cycloalkyl ring.

9. The method of claim 8, wherein each G is independently a substituted or unsubstituted phenyl, pyridyl, cyclohexyl, cyclopentyl, pyrolyl, furyl, thiophenyl, triazolyl, pyrazolyl, 1,3-dioxolanyl, or morpholinyl.

10. The method of claim 8, wherein the substituents, when present, are independently selected from 1 to 3 of methyl, methoxy, and halo.
